(19) United States
(12) Patent Application Publication
(10) Pub. No.: US 2025/0193438 A1
(43) Pub. Date: Jun. 12, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Na ZHANG, Beijing (CN); Kai ZHANG, Los Angeles, CA (US); Bharath VISHWANATH, Los Angeles, CA (US); Li ZHANG, Los Angeles, CA (US)

(21) Appl. No.: 19/056,531

(22) Filed: Feb. 18, 2025

Related U.S. Application Data
(63) Continuation of application No. PCT/CN2023/113842, filed on Aug. 18, 2023.

(30) Foreign Application Priority Data
Aug. 18, 2022 (WO) PCT/CN2022/113249

(51) Int. Cl. H04N 19/54; H04N 19/105; H04N 19/139; H04N 19/172; H04N 19/196

(52) U.S. Cl. CPC H04N 19/54; H04N 19/105; H04N 19/139; H04N 19/172; H04N 19/196

(57) ABSTRACT

Embodiments of the present disclosure provide a solution for video processing. A method for video processing is proposed. The method comprises: determining, for a conversion between a current video block of a video and a bitstream of the video, motion information and location information of at least one subblock of a temporal block in a collocated frame of the current video block; determining an affine candidate of the current video block by applying a regression process to the current video block based on the motion information and the location information of the at least one subblock; and performing the conversion based on the affine candidate.

### CROSS REFERENCE TO RELATED APPLICATIONS

This application is a continuation of International Application No. PCT/CN2023/113842, filed on Aug. 18, 2023, which claims the benefit of International Application No. PCT/CN2022/113249 filed on Aug. 18, 2022. The entire contents of these applications are hereby incorporated by reference in their entireties.

### FIELDS

Embodiments of the present disclosure relates generally to video processing techniques, and more particularly, to regression based affine candidate determination.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a current video block of a video and a bitstream of the video, motion information and location information of at least one subblock of a temporal block in a collocated frame of the current video block; determining an affine candidate of the current video block by applying a regression process to the current video block based on the motion information and the location information of the at least one subblock; and performing the conversion based on the affine candidate. The method in accordance with the first aspect of the present disclosure determines the affine candidate by applying a regression process based on the subblock of a temporal block, thus can improve the coding efficiency and coding effectiveness.

In a second aspect, another method for video processing is proposed. The method comprises: determining, for a conversion between a current video block of a video and a bitstream of the video, motion information and location information of at least one spatial subblock of the current video block; determining an affine candidate of the current video block by applying a regression process to the current video block based on the motion information and the location information of the at least one spatial subblock; and performing the conversion based on the affine candidate. The method in accordance with the second aspect of the present disclosure determines the affine candidate by applying a regression process based on the spatial subblock, thus can improve the coding efficiency and coding effectiveness.

In a third aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a fourth aspect, a non-transitory computer-readable storage medium is proposed. The non-transitory computer-readable storage medium stores instructions that cause a processor to perform a method in accordance with the first aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining motion information and location information of at least one subblock of a temporal block in a collocated frame of a current video block of the video; determining an affine candidate of the current video block by applying a regression process to the current video block based on the motion information and the location information of the at least one subblock; and generating the bitstream based on the affine candidate.

In a sixth aspect, a method for storing a bitstream of a video is proposed. The method comprises: determining motion information and location information of at least one subblock of a temporal block in a collocated frame of a current video block of the video; determining an affine candidate of the current video block by applying a regression process to the current video block based on the motion information and the location information of the at least one subblock; generating the bitstream based on the affine candidate; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: determining motion information and location information of at least one spatial subblock of a current video block of the video; determining an affine candidate of the current video block by applying a regression process to the current video block based on the motion information and the location information of the at least one spatial subblock; and generating the bitstream based on the affine candidate.

In an eighth aspect, a method for storing a bitstream of a video is proposed. The method comprises: determining motion information and location information of at least one spatial subblock of a current video block of the video; determining an affine candidate of the current video block by applying a regression process to the current video block based on the motion information and the location information of the at least one spatial subblock; generating the bitstream based on the affine candidate; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4A and FIG. 4B illustrate control point based affine motion model, respectively;

FIG. 5 illustrates affine MVF per subblock;

FIG. 6 illustrates locations of inherited affine motion predictors;

FIG. 7 illustrates control point motion vector inheritance;

FIG. 8 illustrates locations of candidates position for constructed affine merge mode;

FIG. 9 illustrates an illustration of motion vector usage for proposed combined method;

FIG. 10 illustrates subblock MV VSB and pixel Δv(i,j):

FIGS. 11A and 11B illustrate the SbTMVP process in VVC, where FIG. 11A illustrates spatial neighboring blocks used by ATVMP, and FIG. 11B illustrates deriving sub-CU motion field by applying a motion shift from spatial neighbor and scaling the motion information from the corresponding collocated sub-CUs;

FIG. 12 illustrates first HPT and the second HPT;

FIG. 13 illustrates spatial neighbors for deriving affine merge/AMVP candidates: (a) for deriving inherited candidates (b) for deriving the first type of constructed candidates;

FIG. 14 illustrates from non-adjacent neighbors to the first type of constructed affine merge/AMVP candidates;

FIG. 15 illustrates illustration of the neighboring 4×4 subblocks that are used for RMVF parameter derivation. W and H are the width and height of the current CU;

FIG. 16 illustrates planar motion vector prediction process;

FIG. 17A to FIG. 17D illustrate examples of translational and non-translational motion, respectively, wherein FIG. 17A illustrates translational motion which can be represented by BMME, FIG. 17B illustrates zoom and rotation which can be represented by four-parameter affine model with two control points, FIG. 17C illustrates regular deformation motion which can be represented by six-parameter affine model with three control points, and FIG. 17D illustrates irregular deformation motion which can be represented by bilinear interpolation model with four control points;

FIG. 18A and FIG. 18B illustrate candidate positions for predicting the motion information of each control point of a block, respectively, wherein FIG. 18A illustrates spatial neighbors and FIG. 18B illustrates temporal neighbor;

FIG. 19 illustrates sketch map of bilinear interpolation model for a 16×16 block;

FIG. 20 illustrates the reference samples used in planar mode;

FIG. 21 illustrates positions of spatial merge candidate;

FIG. 22 illustrates candidate pairs considered for redundancy check of spatial merge candidates;

FIG. 23 illustrates an illustration of motion vector scaling for temporal merge candidate;

FIG. 24 illustrates candidate positions for temporal merge candidate, C0 and C1;

FIG. 25 illustrates VVC spatial neighboring blocks of the current block;

FIG. 26 illustrates an illustration of virtual block in the i-th search round;

FIG. 27 illustrates spatial neighboring blocks used to derive the spatial merge candidates;

FIG. 28 illustrates non-adjacent temporal neighboring blocks used to derive the non-adjacent temporal merge candidates;

FIG. 29A and FIG. 29B illustrate derivation of motion information from the adjacent subblocks of the corresponding temporal block in the right column, bottom row, and bottom-right corner, respectively;

FIG. 30A and FIG. 30B illustrate derivation of motion information from the non-adjacent subblocks of the corresponding temporal block in the bottom-right column, bottom-right row, respectively;

FIG. 31 illustrates derivation of motion information from the collocated subblocks of the corresponding temporal block;

FIG. 32 illustrates a flowchart of a method for video processing in accordance with embodiments of the present disclosure;

FIG. 33 illustrates a flowchart of a method for video processing in accordance with embodiments of the present disclosure;

FIG. 34 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

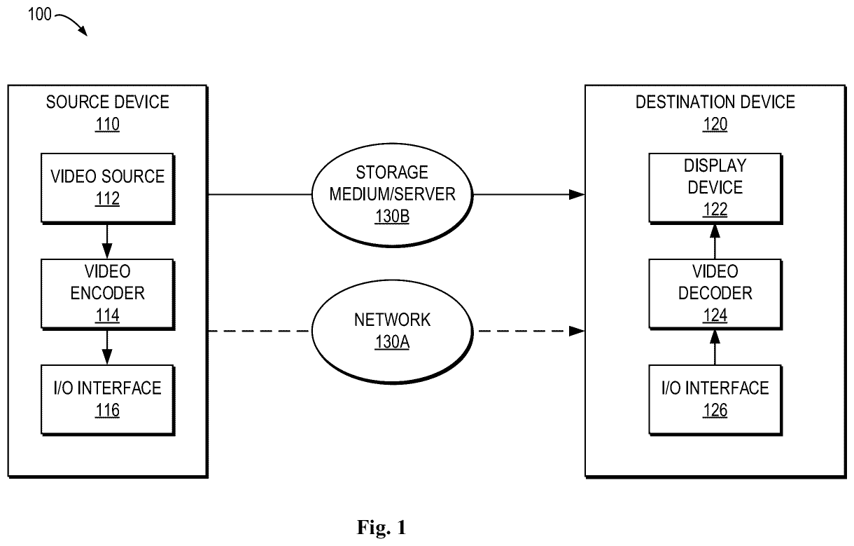

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

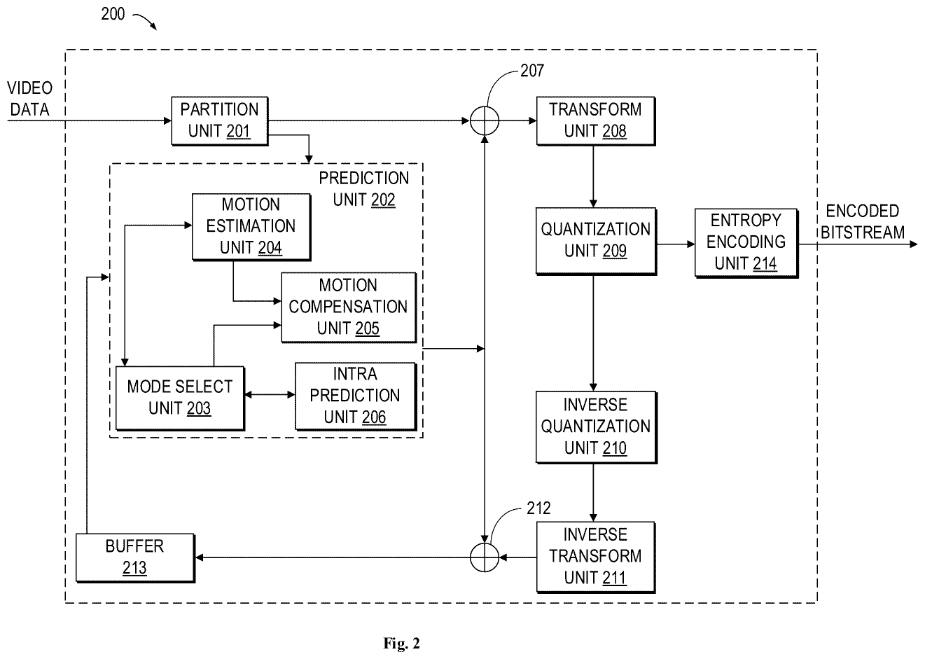

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

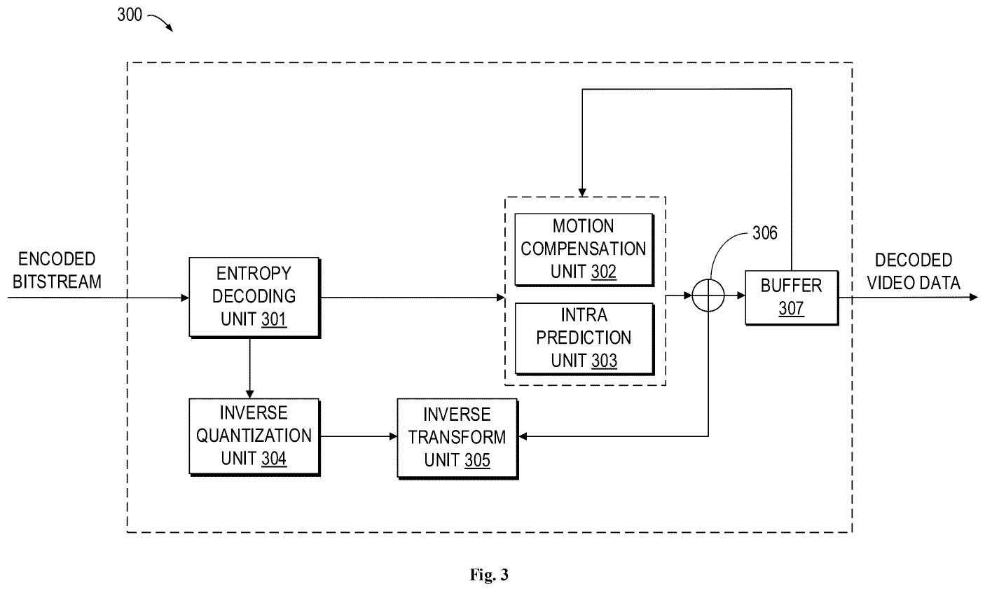

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

This disclosure is related to image/video coding, especially on regression based affine motion prediction. It may be applied to the existing video coding standard like HEVC, or the standard VVC (Versatile Video Coding). It may be also applicable to future video coding standards or video codec.

### 2. Introduction

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized.
To explore the future video coding technologies beyond HEVC, the Joint Video Exploration Team (JVET) was founded by VCEG and MPEG jointly in 2015. The JVET meeting is concurrently held once every quarter, and the new video coding standard was officially named as Versatile Video Coding (VVC) in the April 2018 JVET meeting, and the first version of VVC test model (VTM) was released at that time. The VVC working draft and test model VTM are then updated after every meeting. The VVC project achieved technical completion (FDIS) at the July 2020 meeting.
In January 2021, JVET established an Exploration Experiment (EE), targeting at enhanced compression efficiency beyond VVC capability with novel traditional algorithms. Soon later, ECM was built as the common software base for longer-term exploration work towards the next generation video coding standard.

### 2.1. Affine Motion Compensated Prediction

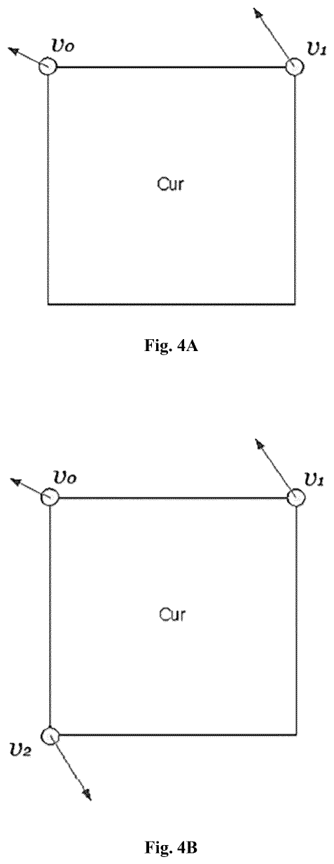

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 4A and FIG. 4B illustrate control point based affine motion model, respectively. FIG. 4A illustrates the 4-parameter affine model. FIG. 4B illustrates the 6-parameter affine model. As shown in FIG. 4A and FIG. 4B, the affine motion field of the block is described by motion information of two control point (4-parameter) or three control point motion vectors (6-parameter).
For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{0 y} - {mv}_{1 y}}{W} y + {mv}_{0 x} \\ {mv}_{y} = \frac{{mv}_{1 y} - {mv}_{0 y}}{W} x + \frac{{mv}_{1 x} - {mv}_{0 x}}{W} y + {mv}_{0 y}\end{matrix} . \qquad ( 2 - 1 )$$

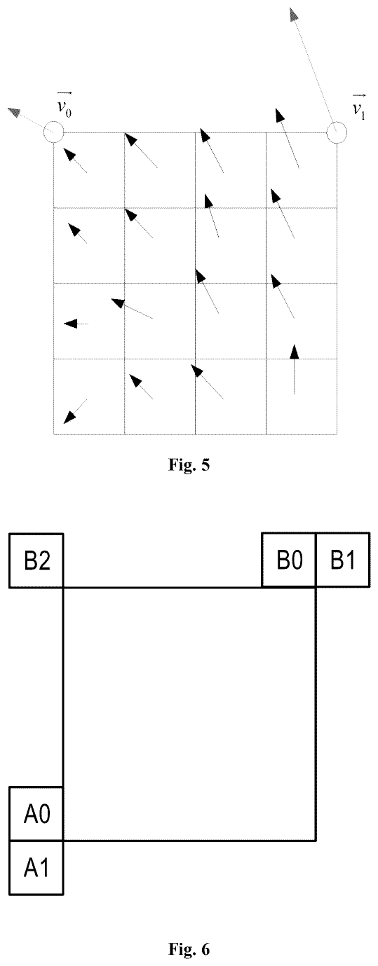

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} . \qquad ( 2 - 2 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.
   In order to simplify the motion compensation prediction, block based affine transform prediction is applied. FIG. 5 illustrates affine MVF per subblock. To derive motion vector of each 4×4 luma subblock, the motion vector of the center sample of each subblock, as shown in FIG. 5, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.
   As done for translational motion inter prediction, there are also two affine motion inter prediction modes: affine merge mode and affine AMVP mode.

### 2.1.1. Affine Merge Prediction

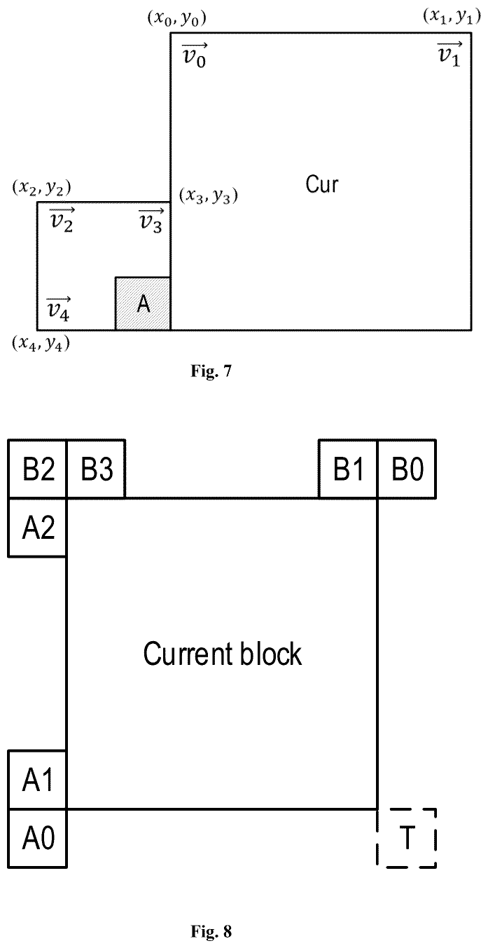

AF_MERGE mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. The following three types of CPVM candidate are used to form the affine merge candidate list:
Inherited affine merge candidates that extrapolated from the CPMVs of the neighbour CUs.
Constructed affine merge candidates CPMVPs that are derived using the translational MVs of the neighbour CUs.
Zero MVs.
   In VVC, there are maximum two inherited affine candidates, which are derived from affine motion model of the neighboring blocks, one from left neighboring CUs and one from above neighboring CUs. FIG. 6 illustrates locations of inherited affine motion predictors. The candidate blocks are shown in FIG. 6. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. FIG. 7 illustrates control point motion vector inheritance. As shown in FIG. 7, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.
   Constructed affine candidate means the candidate is constructed by combining the neighbor translational motion information of each control point. FIG. 8 illustrates locations of candidates position for constructed affine merge mode. The motion information for the control points is derived from the specified spatial neighbors and temporal neighbor shown in FIG. 8. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV₃, the A1->A0 blocks are checked. For TMVP is used as CPMV₄ if it's available.
   After MVs of four control points are attained, affine merge candidates are constructed based on those motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}.
   The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.
   After inherited affine merge candidates and constructed affine merge candidate are checked, if the list is still not full, zero MVs are inserted to the end of the list.

### 2.1.2. Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs.
Constructed affine AMVP candidates CPMVPs that are derived using the translational MVs of the neighbour CUs.
Translational MVs from neighboring CUs.
Zero MVs.
   The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.
   Constructed AMVP candidate is derived from the specified spatial neighbors shown in FIG. 8. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv₀ and mv₁ are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.
   If affine AMVP list candidates is still less than 2 after valid inherited affine AMVP candidates and constructed AMVP candidate are inserted, mv₀, mv₁ and mv₂ will be added, in order, as the translational MVs to predict all control point MVs of the current CU, when available. Finally, zero MVs are used to fill the affine AMVP list if it is still not full.

### 2.1.3. Affine Motion Information Storage

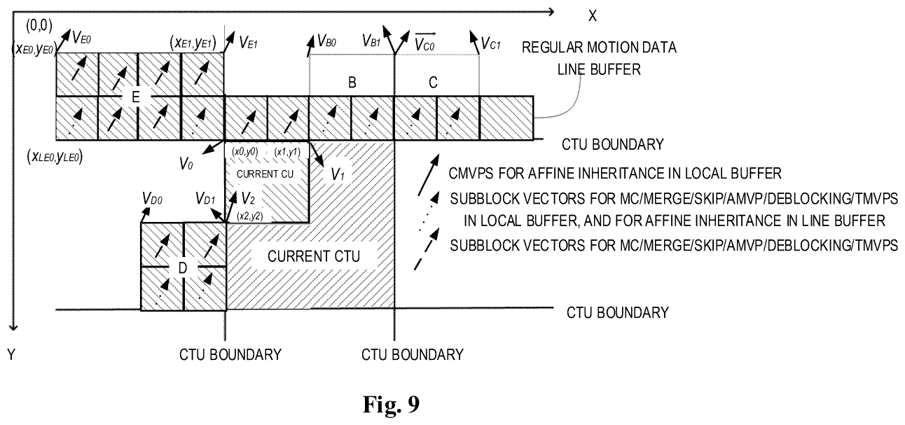

In VVC, the CPMVs of affine CUs are stored in a separate buffer. The stored CPMVs are only used to generate the inherited CPMVPs in affine merge mode and affine AMVP mode for the lately coded CUs. The subblock MVs derived from CPMVs are used for motion compensation, MV derivation of merge/AMVP list of translational MVs and deblocking.
To avoid the picture line buffer for the additional CPMVs, affine motion data inheritance from the CUs from above CTU is treated differently to the inheritance from the normal neighboring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in local buffer. If the candidate CU is 6-parameter affine coded, the affine model is degraded to 4-parameter model. FIG. 9 illustrates an illustration of motion vector usage for proposed combined method. As shown in FIG. 9, along the top CTU boundary, the bottom-left and bottom right subblock motion vectors of a CU are used for affine inheritance of the CUs in bottom CTUs.

### 2.1.4. Prediction Refinement With Optical Flow for Affine Mode

Subblock based affine motion compensation can save memory access bandwidth and reduce computation complexity compared to pixel based motion compensation, at the cost of prediction accuracy penalty. To achieve a finer granularity of motion compensation, prediction refinement with optical flow (PROF) is used to refine the subblock based affine motion compensated prediction without increasing the memory access bandwidth for motion compensation. In VVC, after the subblock based affine motion compensation is performed, luma prediction sample is refined by adding a difference derived by the optical flow equation. The PROF is described as following four steps:
Step 1) The subblock-based affine motion compensation is performed to generate subblock prediction I(i,j).
Step2) The spatial gradients gₓ(i,j) and g_{y}(i,j) of the subblock prediction are calculated at each sample location using a 3-tap filter [−1, 0, 1]. The gradient calculation is exactly the same as gradient calculation in BDOF.

$${g}_{x} ( i , j ) = ( I ( i + 1 , j ) ≫ shift 1 ) - ( I ( i - 1 , j ) ≫ shift 1 ) \qquad ( 2 - 3 )$$

$${g}_{y} ( i , j ) = ( I ( i , j + 1 ) ≫ shift 1 ) - ( I ( i , j - 1 ) ≫ shift 1 ) \qquad ( 2 - 4 )$$

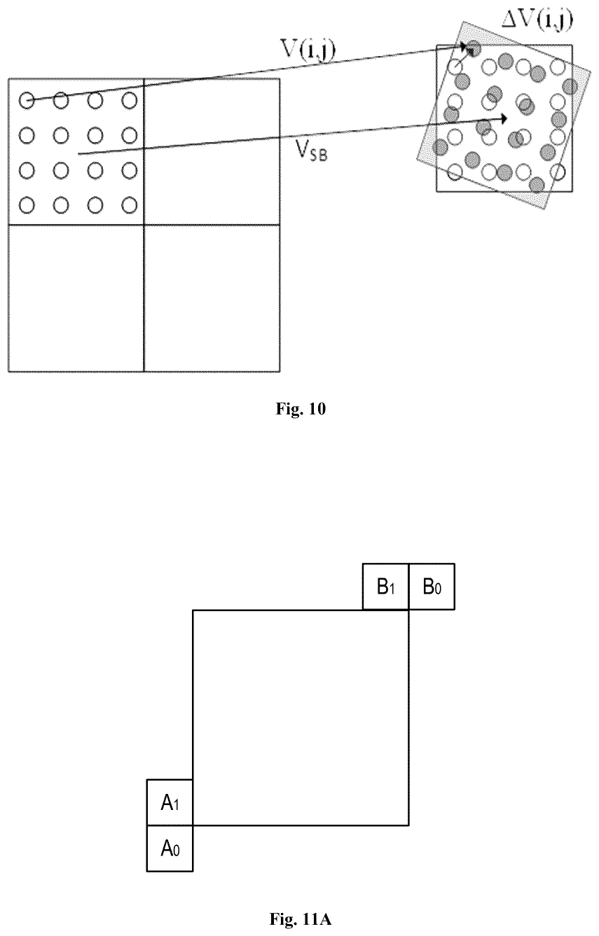

shift1 is used to control the gradient's precision. The subblock (i.e. 4×4) prediction is extended by one sample on each side for the gradient calculation. To avoid additional memory bandwidth and additional interpolation computation, those extended samples on the extended borders are copied from the nearest integer pixel position in the reference picture.
   Step 3) The luma prediction refinement is calculated by the following optical flow equation.

$$Δ I ( i , j ) = {g}_{x} ( i , j ) * Δ {v}_{x} ( i , j ) + {g}_{y} ( i , j ) * Δ {v}_{y} ( i , j ) \qquad ( 2 - 5 )$$

where the Δv(i,j) is the difference between sample MV computed for sample location (i,j), denoted by v(i,j), and the subblock MV of the subblock to which sample (i,j) belongs, as shown in FIG. 10. FIG. 10 illustrates subblock MV VSB and pixel Δv(i,j). The Δv(i,j) is quantized in the unit of 1/32 luam sample precision.
   Since the affine model parameters and the sample location relative to the subblock center are not changed from subblock to subblock, Δv(i,j) can be calculated for the first subblock, and reused for other subblocks in the same CU. Let dx(i,j) and dy(i,j) be the horizontal and vertical offset from the sample location (i,j) to the center of the subblock (x_{SB},y_{SB}), Δv(x,y) can be derived by the following equation,

$$\{ \begin{matrix}dx ( i , j ) = i - {x}_{SB} \\ dy ( i , j ) = j - {y}_{SB}\end{matrix} , \qquad ( 2 - 6 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} . \qquad ( 2 - 7 )$$

In order to keep accuracy, the enter of the subblock (x_{SB},y_{SB}) is calculated as ((W_{SB}−1)/2, (H_{SB}−1)/2), where W_{SB} and H_{SB} are the subblock width and height, respectively.
For 4-parameter affine model,

$$\{ \begin{matrix}C = F = \frac{{v}_{1 x} - {v}_{0 x}}{w} \\ E = - D = \frac{{v}_{1 y} - {v}_{0 y}}{w}\end{matrix} . \qquad ( 2 - 8 )$$

For 6-parameter affine model,

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad ( 2 - 9 )$$

where (v₀ₓ, v_{0y}), (v₁ₓ, v_{1y}), (v₂ₓ, v_{2y}) are the top-left, top-right and bottom-left control point motion vectors, w and h are the width and height of the CU.
   Step 4) Finally, the luma prediction refinement ΔI(i,j) is added to the subblock prediction I(i,j). The final prediction I′ is generated as the following equation.

$${I}^{′} ( i , j ) = I ( i , j ) + Δ I ( i , j )$$

PROF is not be applied in two cases for an affine coded CU: 1) all control point MVs are the same, which indicates the CU only has translational motion; 2) the affine motion parameters are greater than a specified limit because the subblock based affine MC is degraded to CU based MC to avoid large memory access bandwidth requirement.
A fast encoding method is applied to reduce the encoding complexity of affine motion estimation with PROF. PROF is not applied at affine motion estimation stage in following two situations: a) if this CU is not the root block and its parent block does not select the affine mode as its best mode, PROF is not applied since the possibility for current CU to select the affine mode as best mode is low; b) if the magnitude of four affine parameters (C, D, E, F) are all smaller than a predefined threshold and the current picture is not a low delay picture, PROF is not applied because the improvement introduced by PROF is small for this case. In this way, the affine motion estimation with PROF can be accelerated.

### 2.1.5. Adaptive Bypass of Affine ME

If enabled using the VTM encoder parameter AdaptBypassAffineMe, adaptive bypass of affine ME is used as an encoder only operation used to speed up encoding.
Before performing affine ME for a CU, the coding modes of its five spatial neighbours (above, left, above-right, bottom-left, above-left) are checked. If the number of available neighbours is greater than or equal to 4 and none of them are coded as affine or SbTMVP mode, affine ME is bypassed. In addition following two conditions are considered.
1) If a CU is no larger than 16×16, affine ME is not bypassed.
2) If the best mode for a CU is affine merge so far, and the current picture does not have symmetric reference pair (SMVD condition) or the absolute temporal distance between the current picture and SMVD reference is larger than 1, affine ME is not bypassed.

### 2.2. Subblock-Based Temporal Motion Vector Prediction (SbTMVP)

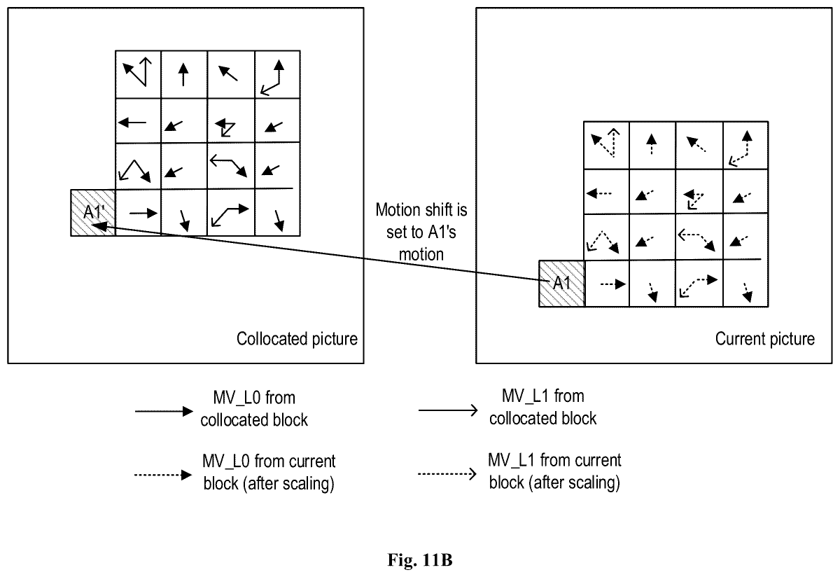

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.
   The SbTVMP process is illustrated in FIG. 11A and FIG. 11B. FIG. 11A illustrates spatial neighboring blocks used by ATVMP. FIG. 11B illustrates deriving sub-CU motion field by applying a motion shift from spatial neighbor and scaling the motion information from the corresponding collocated sub-CUs. SbTMVP predicts the motion vectors of the sub-CUs within the current CU in two steps. In the first step, the spatial neighbor A1 in FIG. 11A is examined. If A1 has a motion vector that uses the collocated picture as its reference picture, this motion vector is selected to be the motion shift to be applied. If no such motion is identified, then the motion shift is set to (0, 0).
   In the second step, the motion shift identified in Step 1 is applied (i.e. added to the current block's coordinates) to obtain sub-CU level motion information (motion vectors and reference indices) from the collocated picture as shown in FIG. 11B. The example in FIG. 11B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.
   In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.
   The sub-CU size used in SbTMVP is fixed to be 8×8, and as done for affine merge mode, SbTMVP mode is only applicable to the CU with both width and height are larger than or equal to 8.
   The encoding logic of the additional SbTMVP merge candidate is the same as for the other merge candidates, that is, for each CU in P or B slice, an additional RD check is performed to decide whether to use the SbTMVP candidate.

### 2.3. History-Parameter-Based Affine Model Inheritance and Non-Adjacent Affine Mode

History-parameter-based affine model inheritance (HAMI) allows the affine model to be inherited from a previously affine-coded block which may not be neighboring to the current block. Similar to the enhanced regular merge mode, non-adjacent affine mode (NA-AFF) is introduced.
A first history-parameter table (HPT) is established. An entry of the first HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as

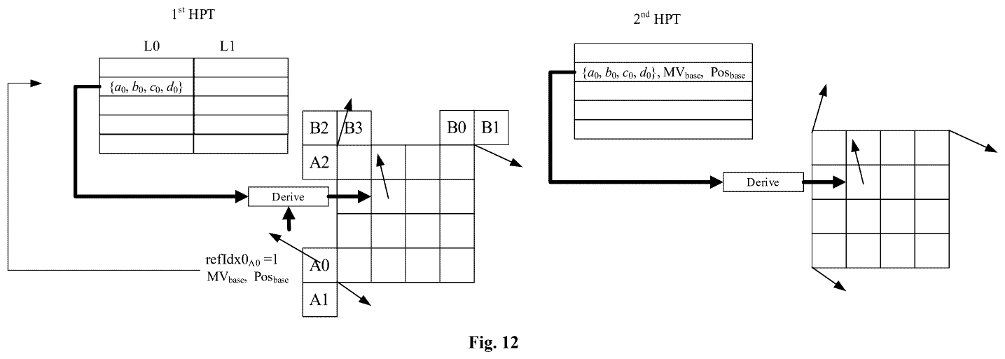

HPTCat(RefList,RefIdx)=5×RefList+min(RefIdx,4),
wherein RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefList_{cur} and RefIdx_{cur}, the affine parameters are utilized to update entries in the category HPTCat(RefList_{cur}, RefIdx_{cur}) in a way similar to HMVP table updating.
   FIG. 12 illustrates first HPT and the second HPT. A history-affine-parameter-based candidate (HAPC) is derived from one of the seven neighbouring 4×4 blocks denoted as A0, A1, A2, B0, B1, B2 or B3 in FIG. 12 and a set of affine parameters stored in a corresponding entry in the first HPT. The MV of a neighbouring 4×4 block served as the base MV. In a formulating way, the MV of the current block at position (x, y) is calculated as:

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} ,$$

where (mv^{h}_{base}, mv^{v}_{base}) represents the MV of the neighbouring 4×4 block, (x_{base}, y_{base}) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

sA second history-parameter table (HPT) with base MV information is also appended. There are nine entries in the second HPT, wherein an entry comprises a base MV, a reference index and four affine parameters for each reference list, and a base position. An additional merge HAPC can be generated from the second HPT with the base MV information the corresponding affine models stored in an entry. The difference between the first HPT and the second HPT is illustrated in FIG. 12.

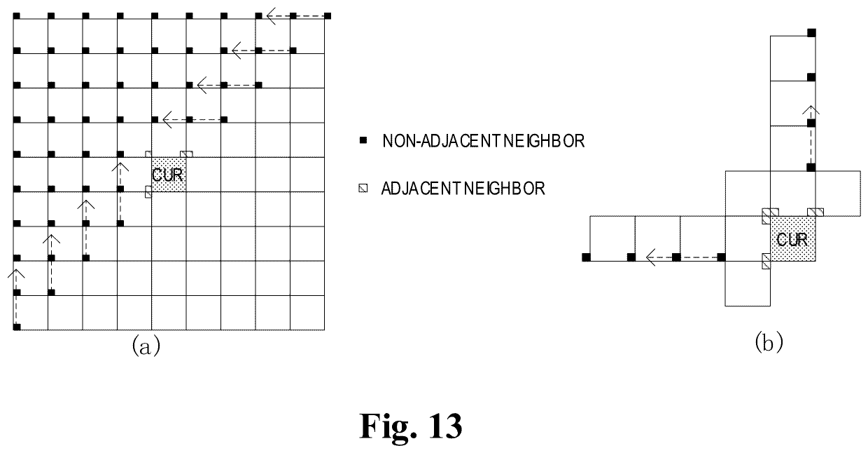

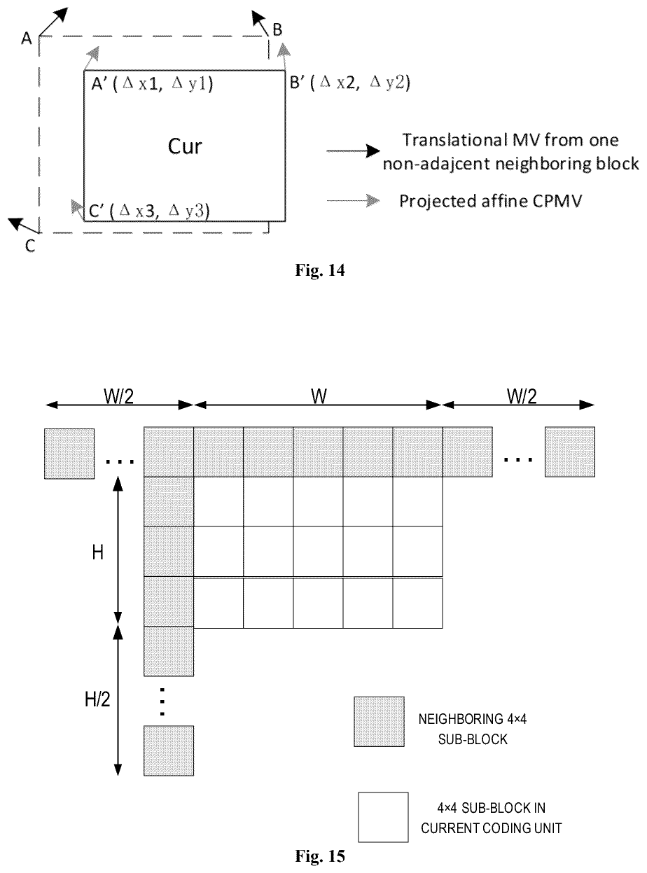

Moreover, pair-wised affine merge candidates are generated by two affine merge candidates which are history-derived or not history-derived. A pair-wised affine merge candidates is generated by averaging the CPMVs of existing affine merge candidates in the list.
As a response to new HAPCs being introduced, the size of sub-block-based merge candidate list is increased from five to fifteen, which are all involved in the ARMC process.
FIG. 13 illustrates spatial neighbors for deriving affine merge/AMVP candidates: (a) for deriving inherited candidates (b) for deriving the first type of constructed candidates. In NA-AFF, the pattern of obtaining non-adjacent spatial neighbors is shown in FIG. 13. Same as the existing non-adjacent regular merge candidates, the distances between non-adjacent spatial neighbors and current coding block in the NA-AFF are also defined based on the width and height of current CU.
The motion information of the non-adjacent spatial neighbors in FIG. 13 is utilized to generate additional inherited and constructed affine merge/AMVP candidates. Specifically, for inherited candidates, the same derivation process of the inherited affine merge/AMVP candidates in the VVC is kept unchanged except that the CPMVs are inherited from non-adjacent spatial neighbors. The non-adjacent spatial neighbors are checked based on their distances to the current block, i.e., from near to far. At a specific distance, only the first available neighbor (that is coded with the affine mode) from each side (e.g., the left and above) of the current block is included for inherited candidate derivation. As indicated by the dash arrows in (a) of FIG. 13, the checking orders of the neighbors on the left and above sides are bottom-to-up and right-to-left, respectively.
FIG. 14 illustrates from non-adjacent neighbors to the first type of constructed affine merge/AMVP candidates.
For the first type of constructed candidates, as shown in the (b) of FIG. 13, the positions of one left and above non-adjacent spatial neighbors are firstly determined independently; After that, the location of the top-left neighbor can be determined accordingly which can enclose a rectangular virtual block together with the left and above non-adjacent neighbors. Then, as shown in the FIG. 14, the motion information of the three non-adjacent neighbors is used to form the CPMVs at the top-left (A), top-right (B) and bottom-left (C) of the virtual block, which is finally projected to the current CU to generate the corresponding constructed candidates.
The NA-AFF candidates are inserted into the existing affine merge candidate list and affine AMVP candidate list according to the following orders:

### Affine Merge Mode:

1. SbTMVP candidate, if available,
2. Inherited from adjacent neighbors,
3. Inherited from non-adjacent neighbors,
4. Constructed from adjacent neighbors,
5. The first type of constructed affine candidates from non-adjacent neighbors,
6. Zero MVs.

### Affine AMVP Mode:

1. Inherited from adjacent neighbors,
2. Constructed from adjacent neighbors,
3. Translational MVs from adjacent neighbors,
4. Translational MVs from temporal neighbors,
5. Inherited from non-adjacent neighbors,
6. The first type of constructed affine candidates from non-adjacent neighbors,
7. Zero MVs.
   Due to the inclusion of the additional candidates generated by NA-AFF, the size of the affine merge candidate list is increased from 5 to 15. The subgroup size of ARMC for the affine merge mode is increased from 3 to 15.

### In NA-AFF:

1. The area from where the non-adjacent neighbors come is restricted to be within the current CTU (i.e., no additional storage requirements for line buffer).
2. The storage granularity for affine motion information, including CPMVs and reference indexes, is reduced from 8×8 to 16×16 (i.e., only the affine motion from the top-left 8×8 block is saved). Additionally, the saved CPMVs are projected to each 16×16 block before storage, such that the position and size information are not needed.
3. Only the top-left and top-right CPMVs are stored (i.e., always using 4-parameter affine model for NA-AFF).

### 2.4. Regression Based Affine Candidate Derivation

During the VVC standardization progress, the Regression based Motion Vector Field (RMVF) derivation method was proposed which provides a new variety of subblock-based merge candidate. The motion vectors and center positions from the neighboring subblocks of the current CU, as illustrated in FIG. 15, are used as the input to the linear regression process to derive a set of linear model parameters. FIG. 15 illustrates illustration of the neighboring 4×4 subblocks that are used for RMVF parameter derivation. W and H are the width and height of the current CU.
Regression based affine candidate derivation method was proposed. the subblock motion field from a previous coded affine CU and the motion vectors from the adjacent subblocks of current CU are used as the input for the regression process. Compares to the regression process, the difference is that the predicted CPMVs instead of the subblock motion field for current block are derived as output. It was decided to test the proposed method in EE2.
This contribution reports the EE test results of the proposed method on top of ECM-5.0. A total of 3 tests have been performed.
In test a, the regression based affine merge candidates are derived and added to the affine merge list. Subblock motion field from a previously coded affine CU and motion information from adjacent subblocks of a current CU are used as the input to the regression process to derive proposed affine candidates.
The previously coded affine CU can be identified from scanning through non-adjacent positions and the affine HMVP table.
Adjacent subblock information of current CU is fetched from 4×4 sub-blocks represented by the grey zone as depicted in FIG. 15. For each sub-block, given a reference list, the corresponding motion vector and center coordinate of the sub-block may be used.
For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found.
In test b, the number of affine candidates for ARMC is increased from 15 to 30, the output list size is kept as 15. Finally in test c, the diversity criterion for ARMC sorting tested in EE2-2.5 are applied on top of test b.

### 2.5. Planar Motion Vector Prediction

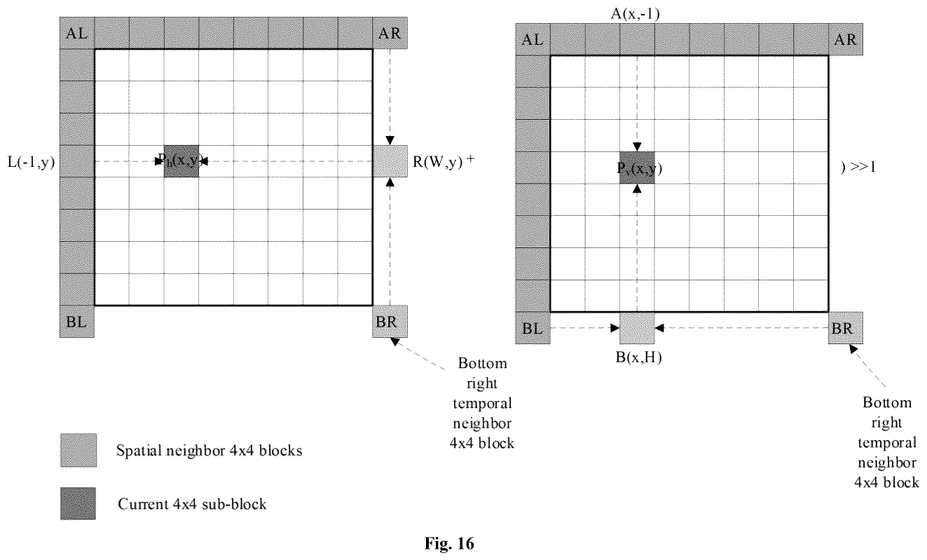

To generate a smooth fine granularity motion field, FIG. 16 gives a brief description of the planar motion vector prediction process. FIG. 16 illustrates planar motion vector prediction process.
Planar motion vector prediction is achieved by averaging a horizontal and vertical linear interpolation on 4×4 block basis as follows.

$$P ( x , y ) = ( H \times {P}_{h} ( x , y ) + W \times {P}_{v} ( x , y ) + H \times W ) / ( 2 \times H \times W )$$

W and H denote the width and the height of the block. (x,y) is the coordinates of current sub-block relative to the above left corner sub-block. All the distances are denoted by the pixel distances divided by 4. P (x, y) is the motion vector of current sub-block.
   The horizontal prediction Pₕ(x, y) and the vertical prediction Pᵥ(x, y) for location (x,y) are calculated as follows:

$$\begin{matrix}{P}_{h} ( x , y ) = ( W - 1 - x ) \times L ( - 1 , y ) + ( x + 1 ) \times R ( W , y ) \\ {P}_{v} ( x , y ) = ( H - 1 - y ) \times A ( x , - 1 ) + ( y + 1 ) \times B ( x , H )\end{matrix}$$

where L(−1, y) and R(W, y) are the motion vectors of the 4×4 blocks to the left and right of the current block. A(x,−1) and B(x, H) are the motion vectors of the 4×4 blocks to the above and bottom of the current block.
   The reference motion information of the left column and above row neighbour blocks are derived from the spatial neighbour blocks of current block.
   The reference motion information of the right column and bottom row neighbour blocks are derived as follows.
1) Derive the motion information of the bottom right temporal neighbour 4×4 block.
2) Compute the motion vectors of the right column neighbour 4×4 blocks, using the derived motion information of the bottom right neighbour 4×4 block along with the motion information of the above right neighbour 4×4 block, as described in Equation (2-10).
3) Compute the motion vectors of the bottom row neighbour 4×4 blocks, using the derived motion information of the bottom right neighbour 4×4 block along with the motion information of the bottom left neighbour 4×4 block, as described in Equation (2-11).

$$R ( W , y ) = ( ( H - y - 1 ) \times AR + ( y + 1 ) \times BR ) / H \qquad ( 2 - 10 )$$

$$B ( x , H ) = ( ( W - x - 1 ) \times BL + ( x + 1 ) \times BR ) / W \qquad ( 2 - 11 )$$

where AR is the motion vector of the above right spatial neighbour 4×4 block, BR is the motion vector of the bottom right temporal neighbour 4×4 block, and BL is the motion vector of the bottom left spatial neighbour 4×4 block.
   The motion information obtained from the neighbouring blocks for each list is scaled to the first reference picture for a given list.

### 2.6. Bilinear Interpolation Model

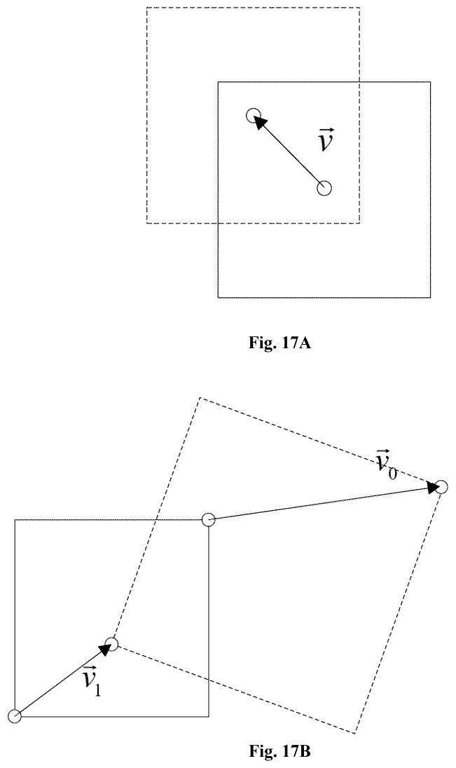

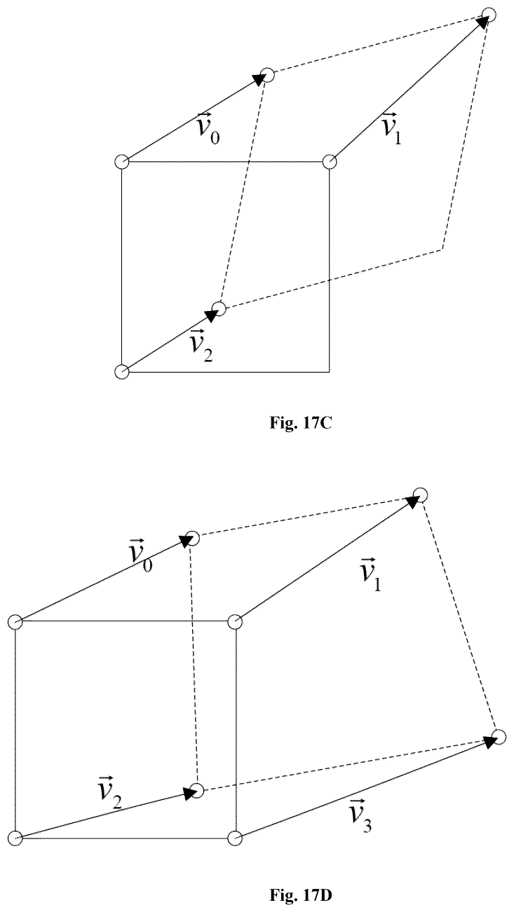

The core idea of bilinear interpolation is performing a linear interpolation in two directions respectively. An example of irregular deformation motion which can be represented by bilinear interpolation model is shown in FIG. 17A to FIG. 17D, where the motion information of each pixel in a block can be computed from the motion information of its four control points according to the bilinear interpolation model. FIG. 17A illustrates translational motion which can be represented by BMME. FIG. 17B illustrates zoom and rotation which can be represented by four-parameter affine model with two control points. FIG. 17C illustrates regular deformation motion which can be represented by six-parameter affine model with three control points. FIG. 17D illustrates irregular deformation motion which can be represented by bilinear interpolation model with four control points.

### 2.6.1. Derivation of Motion Information for Control Points

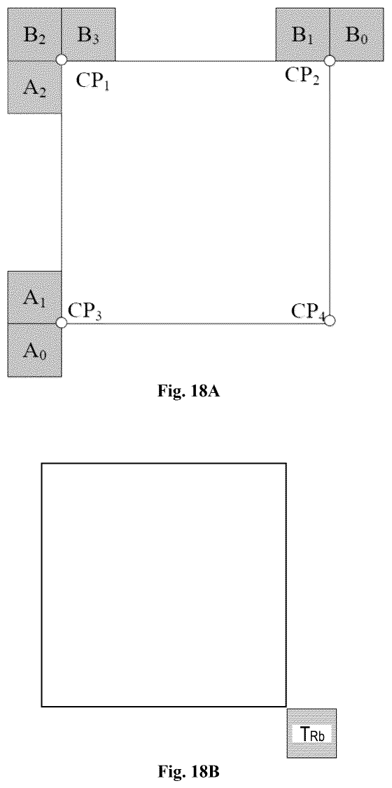

Candidate positions for predicting the motion information of each control point of a block are shown in FIG. 18A and FIG. 18B. FIG. 18A and FIG. 18B illustrate candidate positions for predicting the motion information of each control point of a block, respectively. FIG. 18A illustrates spatial neighbors and FIG. 18B illustrates temporal neighbor. In FIG. 18A and FIG. 18B, CPₖ (k=1,2,3,4) represents the k-th control point. The spatial candidate positions for predicting the motion information of CPₖ (k=1,2,3) are shown in FIG. 18A. The temporal candidate position for predicting the motion information of CP₄ is shown in FIG. 18B.
The motion information of each control point is obtained according to the following priority order:
For CP₁, the checking priority is B₂->A₂->B₃, B₂ is used if it is available. Otherwise, if A₂ is available, A₂ is used. If both A₂ and B₂ are unavailable, B₃ is used. If all the three candidates are unavailable, the motion information of CP₁ cannot be obtained.
For CP₂, the checking priority is B₀->B₁.
For CP₃, the checking priority is A₀->A₁.
For CP₄, T_{Rb} is used.
   Only when the motion information of all the four control points can be derived and they are not identical in at least one reference list, can the motion information of each sub-block in the current block be interpolated.

### 2.6.2. Derivation of Motion Vector for Sub-Block

After deriving the MVs of control points, they are used to interpolate the MV of each sub-block in the current block as following.

$$\vec{MV} = {\sum }_{k = 1}^{4} {ϕ}_{k} {\vec{MV}}_{{CP}_{k}} ;$$

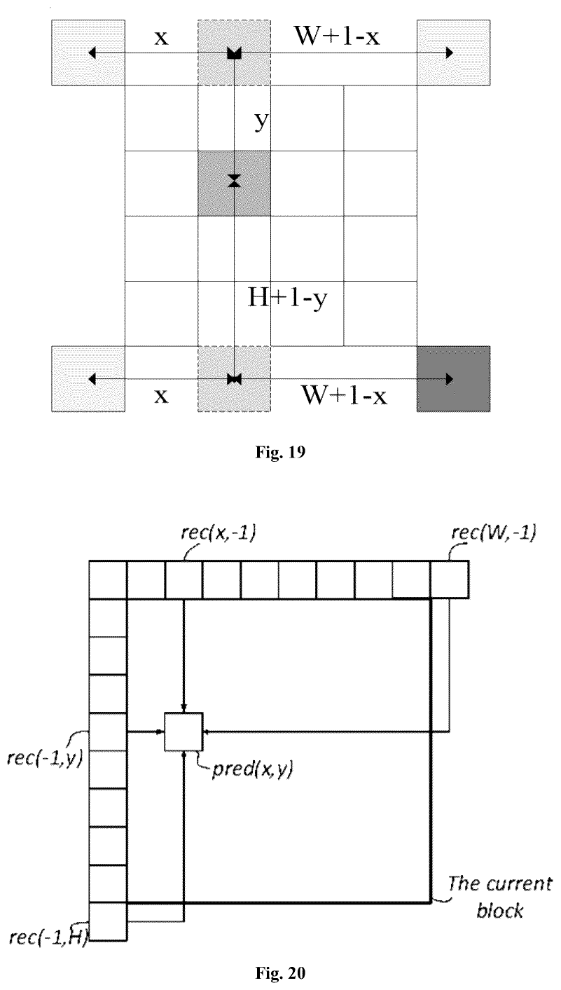

\vec{MV}_{CP}_{ₖ} denotes the MV of the k-th control point and \vec{MV} denotes the MV of current sub-block.
   The interpolation kernel ∥ₖ depends on the contribution of CPₖ to current sub-block. The interpolation function is bilinear interpolation function. Equation (2-12) gives the interpolation kernels corresponding to FIG. 19.

$$\begin{matrix}{ϕ}_{1} = ( ( W + 1 - x ) \cdot ( H + 1 - y ) ) / ( ( W + 1 ) \cdot ( H + 1 ) ) \\ {ϕ}_{2} = ( x \cdot ( H + 1 - y ) ) / ( ( W + 1 ) \cdot ( H + 1 ) ) \\ {ϕ}_{3} = ( ( W + 1 - x ) \cdot y ) / ( ( W + 1 ) \cdot ( H + 1 ) ) \\ {ϕ}_{4} = ( x \cdot y ) / ( ( W + 1 ) \cdot ( H + 1 ) )\end{matrix} . \qquad ( 2 - 12 )$$

In Equation (2-12) and FIG. 19, W and H denote the width and the height of the block. (x, y) is the coordinates of current sub-block. All the distances are denoted by the pixel distances divided by 4.

### 2.6.3. Derivation of Reference Index for Sub-Block

The reference index is used to indicate the reference picture. After determining the motion information of each control point, the reference index for each sub-block is derived as follows.
If all of the four control points have the same reference index, this reference index is selected as the reference index of each sub-block. Otherwise, the reference index with the highest utilization rate among the reference indices of the four control points is selected. Notice the possibility that there may be more than one reference indices with the highest utilization rate. In this situation, the one with the smallest index is selected as the reference index of each sub-block. This is because the reference picture with the smallest reference index has the shortest temporal distance with the current picture.

### 2.6.4. Scaling Motion Vector of Control Point

Before using the MVs of control points to interpolate MV of a sub-block, they should be preprocessed. If the MV of a control point pointing to a different reference picture from the reference picture of the sub-block, the MV is scaled. The scaling process is performed according to the picture order count (POC) distances similar to derivation process for temporal merge candidate.

### 2.7. Planar Horizontal Mode and Planar Vertical Mode

In the planar mode, the predicted value of the current sample is obtained from the reconstructed values of 4 reference samples as shown in FIG. 20. FIG. 20 illustrates the reference samples used in planar mode. Specifically, linear interpolation in the horizontal direction and vertical direction are performed respectively, and the two results are averaged to obtain the predicted sample, as shown in the following equations:

$$predV ( x , y ) = ( ( H - 1 - y ) * rec ( x , - 1 ) + ( y + 1 ) * rec ( - 1 , H ) ) ≪ {log}_{2} W$$

$$predH ( x , y ) = ( ( W - 1 - x ) * rec ( - 1 , y ) + ( x + 1 ) * rec ( W , - 1 ) ) ≪ {log}_{2} H$$

$$pred ( x , y ) = ( predV ( x , y ) + predH ( x , y ) + W * H ) ≫ ( {log}_{2} W + {log}_{2} H + 1 ) .$$

This contribution proposes two additional planar mode: planar horizontal mode and planar vertical mode.
For planar horizontal mode, only the horizontal linear interpolation is performed based on the left reference sample and the top-right reference sample to predict the current sample as:

$$pred ( x , y ) = ( ( W - 1 - x ) * rec ( - 1 , y ) + ( x + 1 ) * rec ( W , - 1 ) + ( W ≫ 1 ) ) ≫ {log}_{2} W .$$

For planar vertical mode, only the vertical linear interpolation is performed based on the above reference sample and the bottom-left reference sample to predict the current sample as:

$$pred ( x , y ) = ( ( H - 1 - y ) * rec ( x , - 1 ) + ( y + 1 ) * rec ( - 1 , H ) + ( H ≫ 1 ) ) ≫ {log}_{2} H .$$

The proposed two additional planar modes are only applied to the luma component and is not used for ISP coded blocks. When the current block enables one of the two proposed planar modes, the block's propagation mode is set to the original planar mode.
For signaling, if the planar flag indicates that a planar mode is used for the current block and the current block is a non-ISP coded luma block, a syntax element is further signaled by truncated unary code to indicate which of the original planar mode, the planar horizontal mode and the planar vertical mode is selected to predict the current block.

### 2.8. Enhanced Temporal Motion Information Derivation

In ECM, the temporal MVP for AMVP mode is derived by fetching the motion information from center or bottom-right location in the collocated frame. And a similar strategy is also applied to sbTMVP mode, where the motion information from the left neighbouring position is used as a motion shift, which is then employed to obtain an MVP at sub-CU level for the to-be-coded CU. It is asserted that such a design may not ensure the trajectory consistency between the pre-defined positions and current CU.
In this proposal, two aspects are proposed to further improve TMVP in sbTMVP and AMVP modes. Firstly, two collocated frames are utilized to provide temporal motion information. Secondly, the motion shift to locate TMVP is adaptively determined from multiple locations according to template costs.
When constructing sub-block-based merge candidate list and AMVP candidate list, two reference frames with the least POC distance relative to the to-be-coded frame are determined to be the collocated frames.
For the two collocated frames, two motion shift candidate lists are constructed respectively. When constructing the motion shift list Li for the i-th collocated frame Ci, the motion information of existing candidates in the motion candidate list are checked. If either MV of the motion candidate points to Ci, the corresponding MV is included into Li serving as a motion shift candidate. The motion shift with the minimum template matching cost is used to derive sbTMVP or TMVP candidate.
ARMC for the sub-block-based merge candidate list is modified accordingly since one more sbTMVP candidate is included. In the proposed method, the sbTMVP candidate that are derived from the first collocated frame is placed in the first entry without reordering. While the other sbTMVP candidate is sorted together with AFFINE candidates.

### 2.9. Extended Merge Prediction

In VVC, the merge candidate list is constructed by including the following five types of candidates in order:
1) Spatial MVP from spatial neighbour CUs.
2) Temporal MVP from collocated CUs.
3) History-based MVP from an FIFO table.
4) Pairwise average MVP.
5) Zero MVs.
   The size of merge list is signalled in sequence parameter set header and the maximum allowed size of merge list is 6. For each CU code in merge mode, an index of best merge candidate is encoded using truncated unary binarization (TU). The first bin of the merge index is coded with context and bypass coding is used for other bins.

The derivation process of each category of merge candidates is provided in this session. As done in HEVC, VVC also supports parallel derivation of the merging candidate lists for all CUs within a certain size of area.

### 2.9.1 Spatial Candidates Derivation

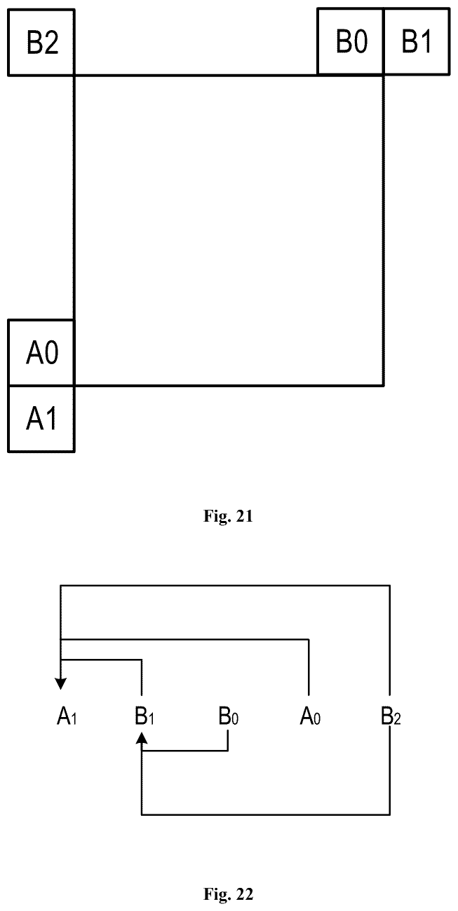

The derivation of spatial merge candidates in VVC is same to that in HEVC except the positions of first two merge candidates are swapped. A maximum of four merge candidates are selected among candidates located in the positions depicted in FIG. 21. FIG. 21 illustrates positions of spatial merge candidate. The order of derivation is B₁, A₁ B₀, A₀, and B₂. Position B₂ is considered only when one or more than one CUs of position B₀, A₀, B₁, A₁ are not available (e.g. because it belongs to another slice or tile) or is intra coded. After candidate at position A₁ is added, the addition of the remaining candidates is subject to a redundancy check which ensures that candidates with same motion information are excluded from the list so that coding efficiency is improved. To reduce computational complexity, not all possible candidate pairs are considered in the mentioned redundancy check. FIG. 22 illustrates candidate pairs considered for redundancy check of spatial merge candidates. Instead only the pairs linked with an arrow in FIG. 22 are considered and a candidate is only added to the list if the corresponding candidate used for redundancy check has not the same motion information.

### 2.9.2 Temporal Candidates Derivation

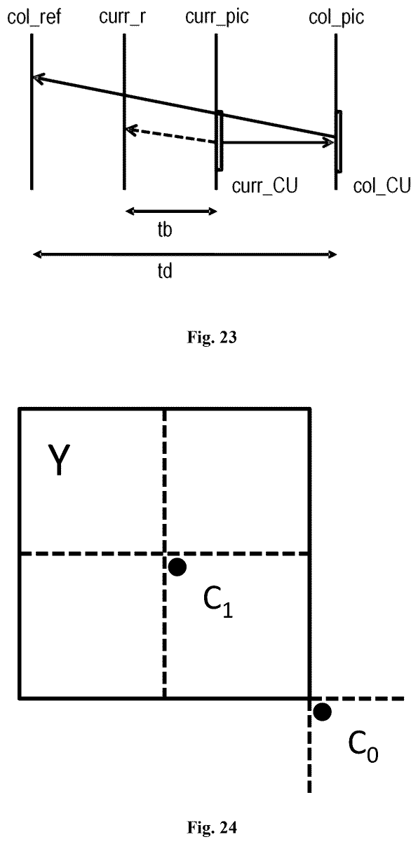

In this step, only one candidate is added to the list. Particularly, in the derivation of this temporal merge candidate, a scaled motion vector is derived based on co-located CU belonging to the collocated reference picture. The reference picture list to be used for derivation of the co-located CU is explicitly signalled in the slice header. FIG. 23 illustrates an illustration of motion vector scaling for temporal merge candidate. The scaled motion vector for temporal merge candidate is obtained as illustrated by the dotted line in FIG. 23, which is scaled from the motion vector of the co-located CU using the POC distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.
The position for the temporal candidate is selected between candidates C₀ and C₁, as depicted in FIG. 24. FIG. 24 illustrates candidate positions for temporal merge candidate, C0 and C1. If CU at position C₀ is not available, is intra coded, or is outside of the current row of CTUs, position C₁ is used. Otherwise, position C₀ is used in the derivation of the temporal merge candidate.

### 2.9.3 History-Based Merge Candidates Derivation

The history-based MVP (HMVP) merge candidates are added to merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.
The HMVP table size S is set to be 6, which indicates up to 5 History-based MVP (HMVP) candidates may be added to the table. When inserting a new motion candidate to the table, a constrained first-in-first-out (FIFO) rule is utilized wherein redundancy check is firstly applied to find whether there is an identical HMVP in the table. If found, the identical HMVP is removed from the table and all the HMVP candidates afterwards are moved forward, and the identical HMVP is inserted to the last entry of the table.
HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.
To reduce the number of redundancy check operations, the following simplifications are introduced:
1. The last two entries in the table are redundancy checked to A₁ and B₁ spatial candidates, respectively.
2. Once the total number of available merge candidates reaches the maximally allowed merge candidates minus 1, the merge candidate list construction process from HMVP is terminated.

### 2.9.4 Pair-Wise Average Merge Candidates Derivation

Pairwise average candidates are generated by averaging predefined pairs of candidates in the existing merge candidate list, and the predefined pairs are defined as {(0, 1), (0, 2), (1, 2), (0, 3), (1, 3), (2, 3)}, where the numbers denote the merge indices to the merge candidate list. The averaged motion vectors are calculated separately for each reference list. If both motion vectors are available in one list, these two motion vectors are averaged even when they point to different reference pictures; if only one motion vector is available, use the one directly; if no motion vector is available, keep this list invalid.
When the merge list is not full after pair-wise average merge candidates are added, the zero MVPs are inserted in the end until the maximum merge candidate number is encountered.

### 2.10. New Merge Candidates

### 2.10.1 Non-Adjacent Merge Candidates Derivation

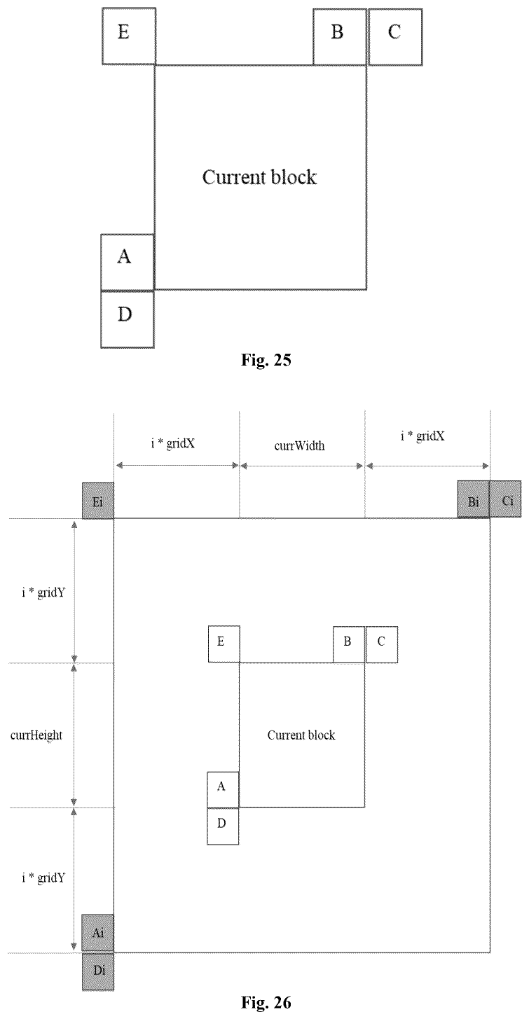

In VVC, five spatially neighboring blocks shown in FIG. 25 as well as one temporal neighbor are used to derive merge candidates. FIG. 25 illustrates VVC spatial neighboring blocks of the current block.
It is proposed to derive the additional merge candidates from the positions non-adjacent to the current block using the same pattern as that in VVC. To achieve this, for each search round i, a virtual block is generated based on the current block as follows:
First, the relative position of the virtual block to the current block is calculated by:

Offsetx=−i×gridX, Offsety=−i×gridY
where the Offsetx and Offsety denote the offset of the top-left corner of the virtual block relative to the top-left corner of the current block, gridX and gridY are the width and height of the search grid.
   Second, the width and height of the virtual block are calculated by:

newWidth=i×2×gridX+currWidth newHeight=i×2×gridY+currHeight.
where the currWidth and currHeight are the width and height of current block. The newWidth and newHeight are the width and height of new virtual block.
gridX and gridY are currently set to currWidth and currHeight, respectively.
   FIG. 26 illustrates an illustration of virtual block in the i-th search round. FIG. 26 illustrates the relationship between the virtual block and the current block.
   After generating the virtual block, the blocks Aᵢ, Bᵢ, Cᵢ, Dᵢ and Eᵢ can be regarded as the VVC spatial neighboring blocks of the virtual block and their positions are obtained with the same pattern as that in VVC. Obviously, the virtual block is the current block if the search round i is 0. In this case, the blocks Aᵢ, Bᵢ, Cᵢ, Dᵢ and Eᵢ are the spatially neighboring blocks that are used in VVC merge mode.
   When constructing the merge candidate list, the pruning is performed to guarantee each element in merge candidate list to be unique. The maximum search round is set to 1, which means that five non-adjacent spatial neighbor blocks are utilized.
   Non-adjacent spatial merge candidates are inserted into the merge list after the temporal merge candidate in the order of B₁->A₁->C₁->D₁->E₁.

### 2.10.2 Non-Adjacent Spatial Candidate

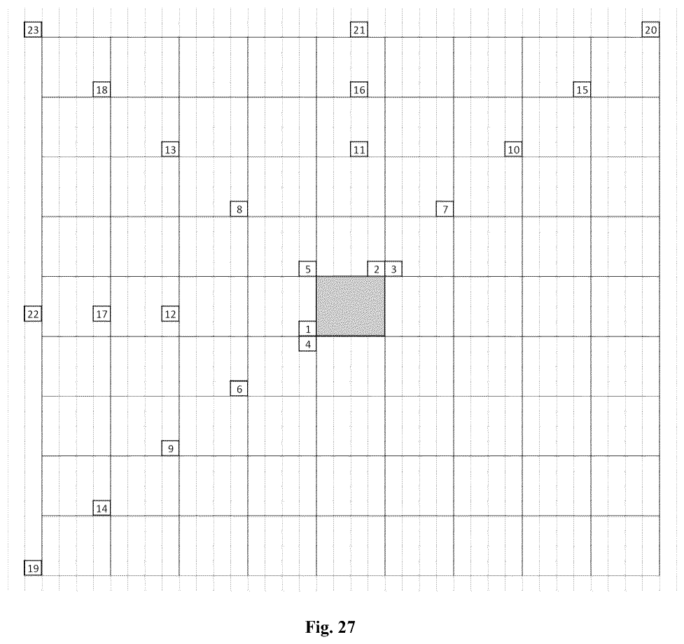

The non-adjacent spatial merge candidates are inserted after the TMVP in the regular merge candidate list. The pattern of spatial merge candidates is shown in FIG. 27. FIG. 27 illustrates spatial neighboring blocks used to derive the spatial merge candidates. The distances between non-adjacent spatial candidates and current coding block are based on the width and height of current coding block. The line buffer restriction is not applied.

### 2.10.3 Non-Adjacent Temporal Candidate

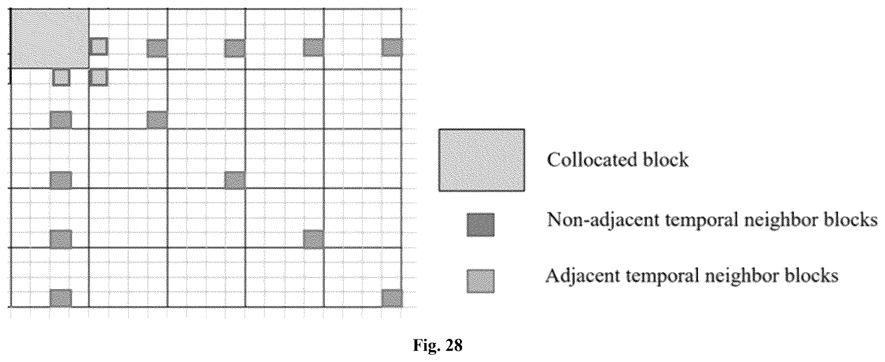

The non-adjacent temporal positions are introduced as shown in FIG. 28, where non-adjacent temporal MVP positions locate in the same reference frame as the adjacent TMVP. FIG. 28 illustrates non-adjacent temporal neighboring blocks used to derive the non-adjacent temporal merge candidates. The distances between non-adjacent temporal candidates and current coding block are based on the width and height of current coding block.

### 3. Problems

The current design of regression based affine candidate derivation can be further improved.

### 4. Detailed Solutions

The detailed embodiments below should be considered as examples to explain general concepts. These embodiments should not be interpreted in a narrow way. Furthermore, these embodiments can be combined in any manner.

### On Regression Based Affine Motion Prediction

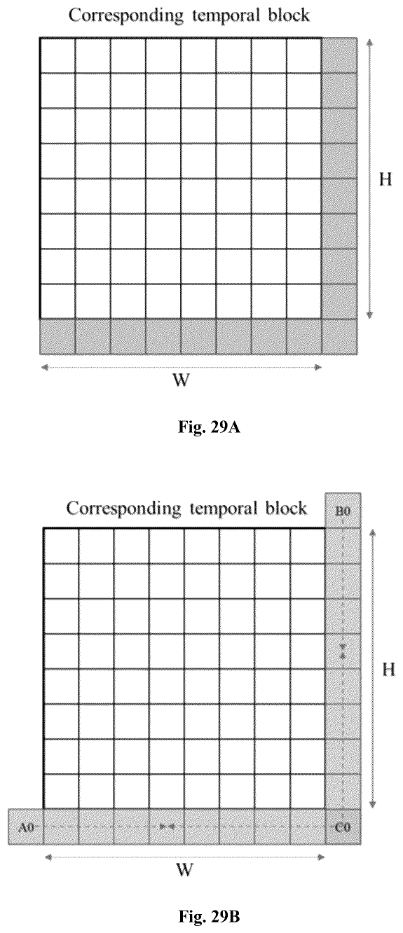

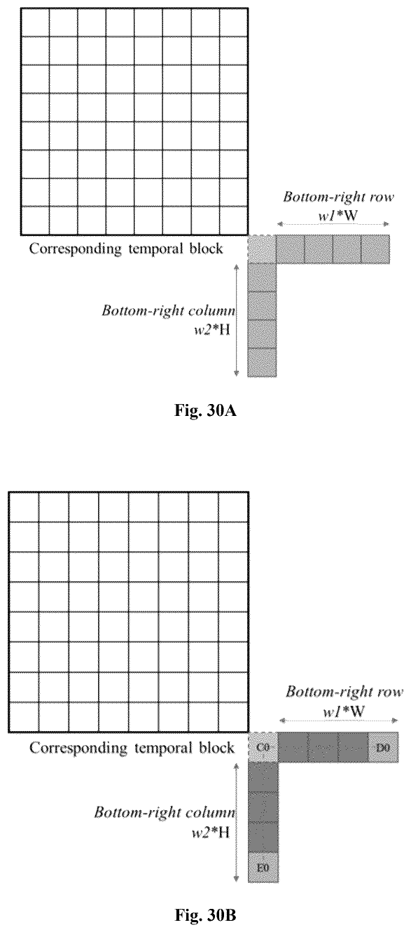

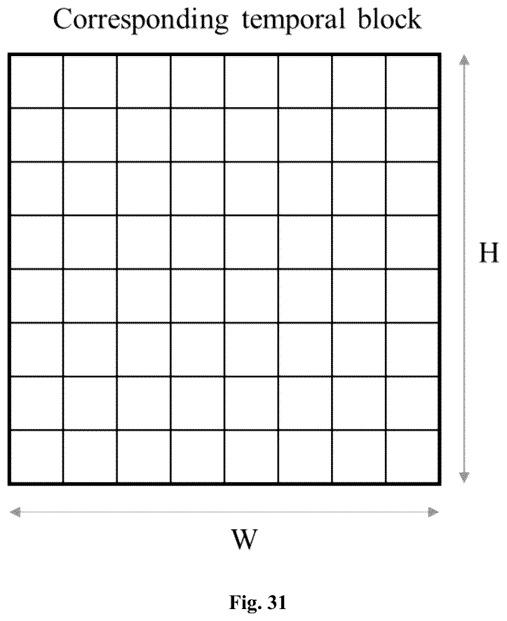

1. The input to the regression process for deriving the affine candidates may involve motion information and their center locations from adjacent and/or non-adjacent and/or collocated subblocks of the corresponding temporal block in the collocated frames for current block.
   a. In one example, the corresponding temporal block for current block may have the same position and the same size as current block in the collocated frames.
   b. In one example, the corresponding temporal block for current block may have the same size as current block but have a motion shift relative to current block in the collocated frames.
      (a) In one example, the motion shift may be derived in the following ways.
         1) In one example, the spatial neighbor A1 in FIG. 21 may be examined. If A1 has a motion vector that uses the collocated picture as its reference picture, this motion vector is selected to be the motion shift to be applied. If no such motion is identified, then the motion shift may be set to one predefined motion vector such as (0, 0).
         2) Alternatively, the spatial neighbors A1 and/or B1 and/or B0 and/or A0 and/or B2 in FIG. 21 may be examined to identify the motion shift.
         i. In one example, the examining order may be A1→B1→B0→A0→B2.
         3) In one example, the motion shift may be set to one predefined motion vector directly.
         i. In one example, the predefined motion vector may be (0,0).
      (b) In one example, if the motion shift is not equal to (0,0), the center locations from adjacent and/or non-adjacent and/or collocated subblocks of the corresponding temporal block in the collocated frames for current block may need to subtract the motion shift.
   c. In one example, the number of the collocated frames may be fixed.
      (a) In one example, the number of the collocated frames may be N (e.g., N is a positive integer).
         1) In one example, the collocated frame may be the same as the collocated frame of temporal candidate derivation which is explicitly signalled in the slice header.
         2) In one example, the collocated frames may be implicitly derived.
         i. In one example, the reference frames with the top N least POC distances relative to current frame may be determined to be the collocated frames.
         ii. In one example, the reference frames with the top N least QPs may be determined to be the collocated frames.
         iii. In one example, the reference frames with the top N least temporal layers may be determined to be the collocated frames.
      (b) Alternatively, the number of the collocated frames may be adaptive.
   d. In one example, motion information from the adjacent subblocks of the corresponding temporal block in the collocated frames for current block may be derived as follows. FIG. 29A and FIG. 29B illustrate derivation of motion information from the adjacent subblocks of the corresponding temporal block in the right column, bottom row, and bottom-right corner, respectively.
      (a) In one example, motion information from the adjacent subblocks in the right column, bottom row, and/or bottom-right corner may be derived similar as temporal candidate derivation in regular merge mode as shown in FIG. 29A.
         1) In one example, the reference picture index of the derived temporal motion information may be predefined such as zero.
         2) In one example, the selected reference picture of the derived temporal motion information may be the one whose scaling factor is the closest to 1.
         3) Alternatively, motion information from the adjacent subblocks in the right column and/or bottom row may be derived by linear interpolation as shown in FIG. 29B.
         i. In one example, motion information from the adjacent subblocks in the right column may be derived by linear interpolation in the vertical direction from motion information of top-right corner and bottom-right corner as shown in FIG. 29B.
         ii. In one example, motion information from the adjacent subblocks in the bottom row may be derived by linear interpolation in the horizontal direction from motion information of bottom-left corner and bottom-right corner as shown in FIG. 29B.
         iii. In one example, the motion information of top-right corner may be spatial or temporal motion information.
         iv. In one example, the motion information of bottom-left corner may be spatial or temporal motion information.
         v. In one example, the motion information of bottom-right corner may be temporal motion information.
         vi. Before performing linear interpolation, both ends or control point pair (e.g., (B0, C0), (A0, C0) in FIG. 29B) of the linear interpolation may need to have the same reference picture.
         (i) In one example, if the two control points have different reference pictures, the linear interpolation may not be performed.
         (ii) In one example, if the two control points have different (ii) reference pictures, the motion vector of one control point may be scaled to point to the reference picture of the other control point.
      (b) In one example, motion information from the adjacent subblocks of the corresponding temporal block in the collocated frames for current block may be derived from adjacent temporal neighboring blocks such as C0 and/or C1 positions as shown in FIG. 24.
   e. In one example, motion information from the non-adjacent subblocks of the corresponding temporal block in the collocated frames for current block may be derived as follows. FIG. 30A and FIG. 30B illustrate derivation of motion information from the non-adjacent subblocks of the corresponding temporal block in the bottom-right column, bottom-right row, respectively.
      (a) In one example, motion information from the non-adjacent subblocks in the bottom-right column and/or bottom-right row may be derived similar as temporal candidate derivation in regular merge mode as shown in FIG. 30A.
         1) In one example, the reference picture index of the derived temporal motion information may be predefined such as zero.
         2) In one example, the selected reference picture of the derived temporal motion information may be the one whose scaling factor is the closest to 1.
         3) Alternatively, motion information from the non-adjacent subblocks in the bottom-right column and/or bottom-right row may be derived by linear interpolation as shown in FIG. 30B.
         i. In one example, motion information from the non-adjacent subblocks in the bottom-right column may be derived by linear interpolation in the vertical direction from motion information of the two control points (e.g., (E0, C0)) of the bottom-right column as shown in FIG. 30B.
         ii. In one example, motion information from the non-adjacent subblocks in the bottom-right row may be derived by linear interpolation in the horizontal direction from motion information of the two control points (e.g., (D0, C0)) of the bottom-right row as shown in FIG. 30B.
         iii. Before performing linear interpolation, both ends or control point pair (e.g., (D0, C0), (E0, C0) in FIG. 30B) of the linear interpolation may need to have the same reference picture.
         (i) In one example, if the two control points have different reference pictures, the linear interpolation may not be performed.
         (ii) In one example, if the two control points have different reference pictures, the motion vector of one control point may be scaled to point to the reference picture of the other control point.
         iv. Before performing linear interpolation, both ends or control point pair (e.g., (D0, C0), (E0, C0) in FIG. 30B) of the linear interpolation may be derived similar as temporal candidate derivation in regular merge mode.
         4) In one example, the length of bottom-right row may be dependent on the width of current block.
         i. In one example, the length of bottom-right row may be a factor (e.g., w1) times the width of current block.
         (i) In one example, the factor may be ½.
         5) In one example, the length of bottom-right column may be dependent on the height of current block.
         i. In one example, the length of bottom-right column may be a factor (e.g., w2) times the height of current block.
         (i) In one example, the factor may be ½.
      (b) In one example, motion information from the non-adjacent subblocks of the corresponding temporal block in the collocated frames for current block may be derived from non-adjacent temporal neighboring blocks such as those in FIG. 28.
   f. In one example, motion information from the collocated subblocks of the corresponding temporal block in the collocated frames for current block may be derived similar as temporal candidate derivation in regular merge mode as shown in FIG. 31. FIG. 31 illustrates derivation of motion information from the collocated subblocks of the corresponding temporal block.
      (a) In one example, the reference picture index of the derived temporal motion information may be predefined such as zero.
      (b) In one example, the selected reference picture of the derived temporal motion information may be the one whose scaling factor is the closest to 1.
   g. In one example, the subblock size may be predefined such as 4×4.
2. The input to the regression process for deriving the affine candidates may involve motion information and their center locations from some additional/alternative spatial adjacent and/or non-adjacent subblocks of current block.
   a. In one example, the additional/alternative spatial adjacent and/or non-adjacent subblocks may be the same as/partial of/inclusive of spatial neighboring blocks used to derive the spatial merge candidates such as those in FIG. 21.
   b. In one example, the additional/alternative spatial adjacent and/or non-adjacent subblocks may be the same as/partial of/inclusive of spatial neighboring blocks used to derive the spatial merge candidates such as those in FIG. 27.

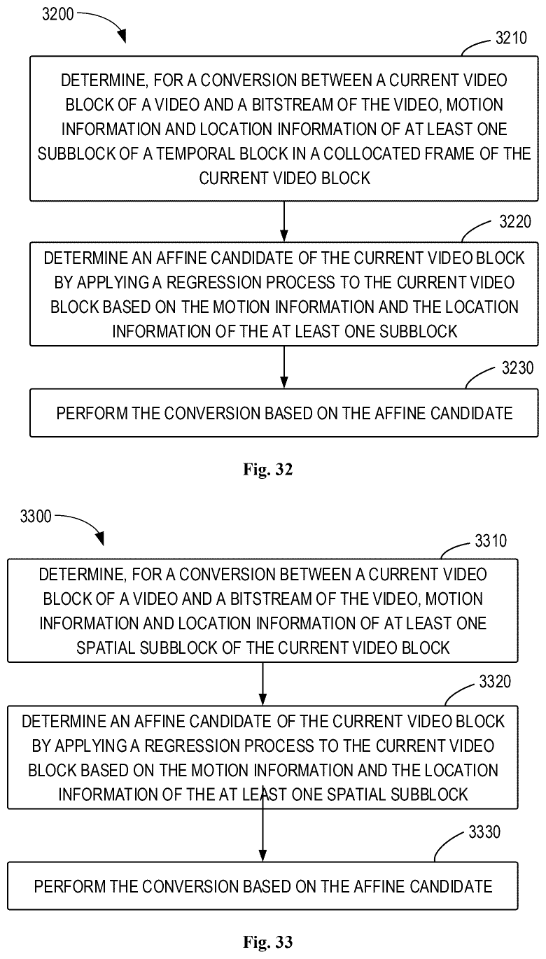

FIG. 32 illustrates a flowchart of a method 3200 for video processing in accordance with embodiments of the present disclosure. The method 3200 is implemented during a conversion between a current video block of a video and a bitstream of the video.

At block 3210, motion information and location information of at least one subblock of a temporal block in a collocated frame of the current video block is determined.

At block 3220, an affine candidate of the current video block is determined by applying a regression process to the current video block based on the motion information and the location information of the at least one subblock.

At block 3230, the conversion is performed based on the affine candidate. In some embodiments, the conversion may include encoding the target video block into the bitstream. Alternatively, or in addition, the conversion may include decoding the target video block from the bitstream.

The method 3200 enables determining the affine candidate based on the subblock of a temporal block, thus improve the coding efficiency and coding effectiveness.

In some embodiments, the at least one subblock of the temporal block comprises at least one of: a subblock adjacent to the temporal block, a subblock non-adjacent to the temporal block, or a collocated subblock in the temporal block.

In some embodiments, a first size of the temporal block is the same with a second size of the current video block.

In some embodiments, a first position of the temporal block in the collocated frame is the same with a second position of the current video block in a current frame including the current video block.

In some embodiments, a motion shift is between a first position of the temporal block in the collocated frame and a second position of the current video block in a current frame including the current video block.

In some embodiments, the method 3200 further comprises: determining whether a motion vector associated with at least one spatial neighbor candidate uses a collocated picture of the current video block as a reference picture; in accordance with a determination that the motion vector uses the collocated picture as the reference picture, determining the motion shift to be the motion vector; and in accordance with a determination that no motion vector associated with the at least one spatial neighbor candidate uses the collocated picture as the reference picture, determining the motion shift to be a predefined vector.

In some embodiments, the at least one spatial neighbor candidate comprises at least one of: a first spatial neighbor candidate left to the current video block, a second spatial neighbor candidate above the current video block, a third spatial neighbor candidate right to the second spatial neighbor candidate, a fourth spatial neighbor candidate below the first spatial neighbor candidate, or a fifth spatial neighbor candidate above and left to the current video block.

In some embodiments, the motion vector is determined for the at least one spatial neighbor candidate based on an order of the first spatial neighbor candidate, the second spatial neighbor candidate, the third spatial neighbor candidate, the fourth spatial candidate, or the fifth spatial candidate.

In some embodiments, the method 3200 further comprises: determining the motion shift to be a predefined vector.

In some embodiments, the predefined vector comprises a zero vector.

In some embodiments, the method 3200 further comprises: determining at least one relative location from the at least one subblock to the current video block; and determining the location information of the at least one subblock by subtracting the motion shift from the relative location.

In some embodiments, determining the location information of the at least one subblock comprises: determining whether the motion shift is a zero vector; in accordance with a determination that the motion shift is the zero vector, determining the location information of the at least one subblock to be the relative location; and in accordance with a determination that the motion shift is not the zero vector, determining the location information of the at least one subblock by subtracting the motion shift from the relative location.

In some embodiments, the current video block comprises a set of collocated frames, the number of collocated frames in the set is fixed or adaptive.

In some embodiments, the set of collocated frames comprises a candidate collocated frame associated with a temporal candidate determination process, information of the candidate collocated frame being included in a slice header in the bitstream.

In some embodiments, the method 3200 further comprises: selecting the set of collocated frames from a plurality of reference frames based on at least one of: a sorting of picture order count distances of the plurality of reference frames relative to a current frame comprising the current video block, a sorting of quantization parameters of the plurality of reference frames, or a sorting of temporal layers associated with the plurality of reference frames.

In some embodiments, the at least one subblock comprises an adjacent subblock of the temporal block, and wherein the motion information of the adjacent subblock is determined based on at least one of: a right column adjacent to the temporal block, a bottom row adjacent to the temporal block, or a bottom-right corner adjacent to the right column and the bottom row.

In some embodiments, the motion information of the adjacent subblock is determined by using a temporal candidate determination used in a regular merge mode.

In some embodiments, a reference picture index associated with the motion information comprises a predefined value. For example, the predefined value may be zero.

In some embodiments, determining the motion information comprises: determining a reference picture from a plurality of candidate reference pictures based on a plurality of scaling factors of the plurality of candidate reference pictures; and determining the motion information based on the reference picture.

In some embodiments, a difference between the scaling factor of the reference picture and a predefined value is the closest among a plurality of differences between scaling factors of a plurality of pictures and the predefined value. For example, the predefined value may be 1.

In some embodiments, the method 3200 further comprises: determining the motion information of the adjacent subblock by applying a linear interpolation to at least one of: first motion information of a top-right corner above the right column and second motion information of the bottom-right corner, or third motion information of a bottom-left corner left to the bottom row and the second motion information of the bottom-right corner.

In some embodiments, the first motion information of the top-right corner comprises at least one of: spatial motion information of the top-right corner or temporal motion information of the top-right corner.

In some embodiments, the third motion information of the bottom-left corner comprises at least one of: spatial motion information of the bottom-left corner or temporal motion information of the bottom-left corner.

In some embodiments, the second motion information of the bottom-right corner comprises temporal motion information of the bottom-right corner.

In some embodiments, the top-right corner, the bottom-left corner and the bottom-right corner are associated with a same reference picture.

In some embodiments, the method 3200 further comprises: in accordance with a determination that two control points of the top-right corner, the bottom-left corner and the bottom-right corner are associated with different reference pictures, ceasing applying the linear interpolation.

In some embodiments, the method 3200 further comprises: in accordance with a determination that two control points of the top-right corner, the bottom-left corner and the bottom-right corner have different reference pictures, scaling a first control point of the two control points based on a motion vector of the first control point to point to the reference picture of a second control point of the two control points.

In some embodiments, the at least one subblock comprises an adjacent subblock of the temporal block, and wherein the motion information of the adjacent subblock is determined based on at least one of: a first temporal neighboring block at a center position of a co-located block of the current video block, or a second temporal neighboring block at a position right to and below a co-located block of the current video block.

In some embodiments, the at least one subblock comprises a non-adjacent subblock of the temporal block, and wherein the motion information of the non-adjacent subblock is determined based on at least one of: a bottom-right column below and right to the temporal block, or a bottom-right row below and right to the temporal block.

In some embodiments, the motion information of the non-adjacent subblock is determined by using a temporal candidate determination used in a regular merge mode.

In some embodiments, a reference picture index associated with the motion information comprises a predefined value. For example, the predefined value may be zero.

In some embodiments, determining the motion information comprises: determining a reference picture from a plurality of candidate reference pictures based on a plurality of scaling factors of the plurality of candidate reference pictures; and determining the motion information based on the reference picture.

In some embodiments, a difference between the scaling factor of the reference picture and a predefined value is the closest among a plurality of differences between scaling factors of a plurality of pictures and the predefined value. For example, the predefined value may be 1.

In some embodiments, the method 3200 further comprises: determining the motion information of the non-adjacent subblock by applying a linear interpolation to at least one of: fourth motion information and fifth motion information associated with the bottom-right column, or sixth motion information and seventh motion information associated with the bottom-right row.

In some embodiments, at least one of the fourth motion information or the fifth motion information or the sixth motion information or the seventh motion information comprises temporal motion information.

In some embodiments, determining the motion information of the non-adjacent subblock by applying a linear interpolation comprises: determining a first control point and a second control point in the bottom-right column; and determining the motion information of the non-adjacent subblock by applying the linear interpolation in a vertical direction to the fourth and fifth motion information of the first and second control points.

In some embodiments, determining the motion information of the non-adjacent subblock by applying a linear interpolation comprises: determining a third control point and a fourth control point in the bottom-right row; and determining the motion information of the non-adjacent subblock by applying the linear interpolation in a horizontal direction to the sixth and seventh motion information of the third and fourth control points.

In some embodiments, the first, second, third and fourth control points are associated with a same reference picture.

In some embodiments, the method 3200 further comprises: in accordance with a determination that two of the first, second, third and fourth control points are associated with different reference pictures, ceasing applying the linear interpolation.

In some embodiments, the method 3200 further comprises: in accordance with a determination that two of the first, second, third and fourth control points are associated with different reference pictures, scaling a given one of the two control points based on a motion vector of the given one control point to point to a reference picture of another control point of the two control points.

In some embodiments, the first, second, third and fourth control points are determined by using a temporal candidate determination used in a regular merge mode.

In some embodiments, a first length of the bottom-right row is based on a width of the current video block.

In some embodiments, the first length is determined based on the width and a first factor.

In some embodiments, the first factor is ½.

In some embodiments, a second length of the bottom-right column is based on a height of the current video block.

In some embodiments, the second length is determined based on the height and a second factor.

In some embodiments, the second factor is ½.

In some embodiments, the at least one subblock comprises a non-adjacent subblock of the temporal block, and wherein the non-adjacent subblock is determined based on a plurality of non-adjacent temporal neighboring blocks. For example, the plurality of non-adjacent temporal neighboring blocks may be the neighboring blocks shown in FIG. 28.

In some embodiments, the at least one subblock comprises a collocated subblock of the temporal block, and wherein the motion information of the collocated subblock is determined by using a temporal candidate determination used in a regular merge mode.

In some embodiments, a reference picture index of the motion information of the collocated subblock comprises a predefined value. For example, the predefined value of the reference picture index may be 0.

In some embodiments, determining the motion information of the collocated subblock comprises: determining a reference picture from a plurality of candidate reference pictures based on a plurality of scaling factors of the plurality of candidate reference pictures; and determining the motion information based on the reference picture.

In some embodiments, a difference between the scaling factor of the reference picture and a predefined value is the closest among a plurality of differences between scaling factors of a plurality of pictures and the predefined value. For example, the predefined value may be 1. The selected reference picture of the derived temporal motion information may be the one whose scaling factor is the closest to 1.

In some embodiments, a size of the at least one subblock is predefined, such as 4×4.

According to further embodiments of the present disclosure, a non-transitory computer-readable recording medium is provided. The non-transitory computer-readable recording medium stores a bitstream of a video which is generated by a method performed by an apparatus for video processing. The method comprises: determining motion information and location information of at least one subblock of a temporal block in a collocated frame of a current video block of the video; determining an affine candidate of the current video block by applying a regression process to the current video block based on the motion information and the location information of the at least one subblock; and generating the bitstream based on the affine candidate.

According to still further embodiments of the present disclosure, a method for storing bitstream of a video is provided. The method comprises: determining motion information and location information of at least one subblock of a temporal block in a collocated frame of a current video block of the video; determining an affine candidate of the current video block by applying a regression process to the current video block based on the motion information and the location information of the at least one subblock; generating the bitstream based on the affine candidate; and storing the bitstream in a non-transitory computer-readable recording medium.

FIG. 33 illustrates a flowchart of a method 3300 for video processing in accordance with embodiments of the present disclosure. The method 3300 is implemented during a conversion between a current video block of a video and a bitstream of the video.

At block 3310, motion information and location information of at least one spatial subblock of the current video block is determined.

At block 3320, an affine candidate of the current video block is determined by applying a regression process to the current video block based on the motion information and the location information of the at least one spatial subblock.

At block 3330, the conversion is performed based on the affine candidate. In some embodiments, the conversion may include encoding the target video block into the bitstream. Alternatively, or in addition, the conversion may include decoding the target video block from the bitstream.

The method 3300 enables determining the affine candidate based on the spatial subblock, thus improve the coding efficiency and coding effectiveness.

In some embodiments, the at least one spatial subblock of the current video block comprises at least one of: a spatial subblock adjacent to the current video block, or a spatial subblock non-adjacent to the current video block.

In some embodiments, the at least one spatial subblock comprises at least a part of a set of spatial subblocks used to determine at least one spatial merge candidate of the current video block.

In some embodiments, the at least one spatial subblock further comprises a spatial subblock not in the set of spatial subblocks.

In some embodiments, the at least one spatial merge candidate comprises at least one of: a first spatial neighbor candidate left to the current video block, a second spatial neighbor candidate above the current video block, a third spatial neighbor candidate right to the second spatial neighbor candidate, a fourth spatial neighbor candidate below the first spatial neighbor candidate, or a fifth spatial neighbor candidate above and left to the current video block. For example, the at least one spatial merge candidate may be shown in FIG. 21.

In some embodiments, the set of spatial subblocks is predetermined. For example, the set of spatial subblocks may be shown in FIG. 27.

According to further embodiments of the present disclosure, a non-transitory computer-readable recording medium is provided. The non-transitory computer-readable recording medium stores a bitstream of a video which is generated by a method performed by an apparatus for video processing. The method comprises: determining motion information and location information of at least one spatial subblock of a current video block of the video; determining an affine candidate of the current video block by applying a regression process to the current video block based on the motion information and the location information of the at least one spatial subblock; and generating the bitstream based on the affine candidate.

According to still further embodiments of the present disclosure, a method for storing bitstream of a video is provided. The method comprises: determining motion information and location information of at least one spatial subblock of a current video block of the video; determining an affine candidate of the current video block by applying a regression process to the current video block based on the motion information and the location information of the at least one spatial subblock; generating the bitstream based on the affine candidate; and storing the bitstream in a non-transitory computer-readable recording medium.

It is to be understood that the above method 3200 and/or method 3300 may be used in combination or separately. Any suitable combination of these methods may be applied. Scope of the present disclosure is not limited in this regard.

By using these methods 3200 and 3300 separately or in combination, the affine candidate may be improved. In this way, the coding effectiveness and coding efficiency can be improved.

Implementations of the present disclosure can be described in view of the following clauses, the features of which can be combined in any reasonable manner.
Clause 1. A method for video processing, comprising: determining, for a conversion between a current video block of a video and a bitstream of the video, motion information and location information of at least one subblock of a temporal block in a collocated frame of the current video block; determining an affine candidate of the current video block by applying a regression process to the current video block based on the motion information and the location information of the at least one subblock; and performing the conversion based on the affine candidate.
Clause 2. The method of clause 1, wherein the at least one subblock of the temporal block comprises at least one of: a subblock adjacent to the temporal block, a subblock non-adjacent to the temporal block, or a collocated subblock in the temporal block.
Clause 3. The method of clause 1 or clause 2, wherein a first size of the temporal block is the same with a second size of the current video block.
Clause 4. The method of any of clauses 1-3, wherein a first position of the temporal block in the collocated frame is the same with a second position of the current video block in a current frame including the current video block.
Clause 5. The method of any of clauses 1-3, wherein a motion shift is between a first position of the temporal block in the collocated frame and a second position of the current video block in a current frame including the current video block.
Clause 6. The method of clause 5, further comprising: determining whether a motion vector associated with at least one spatial neighbor candidate uses a collocated picture of the current video block as a reference picture; in accordance with a determination that the motion vector uses the collocated picture as the reference picture, determining the motion shift to be the motion vector; and in accordance with a determination that no motion vector associated with the at least one spatial neighbor candidate uses the collocated picture as the reference picture, determining the motion shift to be a predefined vector.
Clause 7. The method of clause 6, wherein the at least one spatial neighbor candidate comprises at least one of: a first spatial neighbor candidate left to the current video block, a second spatial neighbor candidate above the current video block, a third spatial neighbor candidate right to the second spatial neighbor candidate, a fourth spatial neighbor candidate below the first spatial neighbor candidate, or a fifth spatial neighbor candidate above and left to the current video block.
Clause 8. The method of clause 7, wherein the motion vector is determined for the at least one spatial neighbor candidate based on an order of the first spatial neighbor candidate, the second spatial neighbor candidate, the third spatial neighbor candidate, the fourth spatial candidate, or the fifth spatial candidate.
Clause 9. The method of clause 5, further comprising: determining the motion shift to be a predefined vector.
Clause 10. The method of clause 6 or clause 9, wherein the predefined vector comprises a zero vector.
Clause 11. The method of any of clauses 5-10, further comprising: determining at least one relative location from the at least one subblock to the current video block; and determining the location information of the at least one subblock by subtracting the motion shift from the relative location.
Clause 12. The method of clause 11, wherein determining the location information of the at least one subblock comprises: determining whether the motion shift is a zero vector; in accordance with a determination that the motion shift is the zero vector, determining the location information of the at least one subblock to be the relative location; and in accordance with a determination that the motion shift is not the zero vector, determining the location information of the at least one subblock by subtracting the motion shift from the relative location.
Clause 13. The method of any of clauses 1-12, wherein the current video block comprises a set of collocated frames, the number of collocated frames in the set is fixed or adaptive.
Clause 14. The method of clause 13, wherein the set of collocated frames comprises a candidate collocated frame associated with a temporal candidate determination process, information of the candidate collocated frame being included in a slice header in the bitstream.
Clause 15. The method of clause 13, further comprising: selecting the set of collocated frames from a plurality of reference frames based on at least one of: a sorting of picture order count distances of the plurality of reference frames relative to a current frame comprising the current video block, a sorting of quantization parameters of the plurality of reference frames, or a sorting of temporal layers associated with the plurality of reference frames.
Clause 16. The method of any of clauses 1-15, wherein the at least one subblock comprises an adjacent subblock of the temporal block, and wherein the motion information of the adjacent subblock is determined based on at least one of: a right column adjacent to the temporal block, a bottom row adjacent to the temporal block, or a bottom-right corner adjacent to the right column and the bottom row.
Clause 17. The method of clause 16, wherein the motion information of the adjacent subblock is determined by using a temporal candidate determination used in a regular merge mode.
Clause 18. The method of clause 16 or clause 17, wherein a reference picture index associated with the motion information comprises a predefined value.
Clause 19. The method of any of clauses 16-18, wherein determining the motion information comprises: determining a reference picture from a plurality of candidate reference pictures based on a plurality of scaling factors of the plurality of candidate reference pictures; and determining the motion information based on the reference picture.
Clause 20. The method of clause 19, wherein a difference between the scaling factor of the reference picture and a predefined value is the closest among a plurality of differences between scaling factors of a plurality of pictures and the predefined value.
Clause 21. The method of clause 20, wherein the predefined value comprises 1.
Clause 22. The method of clause 16, further comprising: determining the motion information of the adjacent subblock by applying a linear interpolation to at least one of: first motion information of a top-right corner above the right column and second motion information of the bottom-right corner, or third motion information of a bottom-left corner left to the bottom row and the second motion information of the bottom-right corner.
Clause 23. The method of clause 22, wherein the first motion information of the top-right corner comprises at least one of: spatial motion information of the top-right corner or temporal motion information of the top-right corner.
Clause 24. The method of clause 22 or clause 23, wherein the third motion information of the bottom-left corner comprises at least one of: spatial motion information of the bottom-left corner or temporal motion information of the bottom-left corner.
Clause 25. The method of any of clauses 22-24, wherein the second motion information of the bottom-right corner comprises temporal motion information of the bottom-right corner.
Clause 26. The method of any of clauses 22-25, wherein the top-right corner, the bottom-left corner and the bottom-right corner are associated with a same reference picture.
Clause 27. The method of any of clauses 22-25, further comprising: in accordance with a determination that two control points of the top-right corner, the bottom-left corner and the bottom-right corner are associated with different reference pictures, ceasing applying the linear interpolation.
Clause 28. The method of any of clauses 22-25, further comprising: in accordance with a determination that two control points of the top-right corner, the bottom-left corner and the bottom-right corner have different reference pictures, scaling a first control point of the two control points based on a motion vector of the first control point to point to the reference picture of a second control point of the two control points.
Clause 29. The method of any of clauses 1-15, wherein the at least one subblock comprises an adjacent subblock of the temporal block, and wherein the motion information of the adjacent subblock is determined based on at least one of: a first temporal neighboring block at a center position of a co-located block of the current video block, or a second temporal neighboring block at a position right to and below a co-located block of the current video block.
Clause 30. The method of any of clauses 1-15, wherein the at least one subblock comprises a non-adjacent subblock of the temporal block, and wherein the motion information of the non-adjacent subblock is determined based on at least one of: a bottom-right column below and right to the temporal block, or a bottom-right row below and right to the temporal block.
Clause 31. The method of clause 30, wherein the motion information of the non-adjacent subblock is determined by using a temporal candidate determination used in a regular merge mode.
Clause 32. The method of clause 30 or clause 31, wherein a reference picture index associated with the motion information comprises a predefined value.
Clause 33. The method of any of clauses 30-32, wherein determining the motion information comprises: determining a reference picture from a plurality of candidate reference pictures based on a plurality of scaling factors of the plurality of candidate reference pictures; and determining the motion information based on the reference picture.
Clause 34. The method of clause 33, wherein a difference between the scaling factor of the reference picture and a predefined value is the closest among a plurality of differences between scaling factors of a plurality of pictures and the predefined value.
Clause 35. The method of clause 34, wherein the predefined value comprises 1.
Clause 36. The method of clause 30, further comprising: determining the motion information of the non-adjacent subblock by applying a linear interpolation to at least one of: fourth and fifth motion information associated with the bottom-right column, or sixth and seventh motion information associated with the bottom-right row.
Clause 37. The method of clause 36, wherein at least one of the fourth motion information or the fifth motion information or the sixth motion information or the seventh motion information comprises temporal motion information.
Clause 38. The method of clause 36, wherein determining the motion information of the non-adjacent subblock by applying a linear interpolation comprises: determining a first control point and a second control point in the bottom-right column; and determining the motion information of the non-adjacent subblock by applying the linear interpolation in a vertical direction to the fourth and fifth motion information of the first and second control points.
Clause 39. The method of clause 38, wherein determining the motion information of the non-adjacent subblock by applying a linear interpolation comprises: determining a third control point and a fourth control point in the bottom-right row; and determining the motion information of the non-adjacent subblock by applying the linear interpolation in a horizontal direction to the sixth and seventh motion information of the third and fourth control points.
Clause 40. The method of clause 39, wherein the first, second, third and fourth control points are associated with a same reference picture.
Clause 41. The method of clause 39 or clause 40, further comprising: in accordance with a determination that two of the first, second, third and fourth control points are associated with different reference pictures, ceasing applying the linear interpolation.
Clause 42. The method of clause 39 or clause 40, further comprising: in accordance with a determination that two of the first, second, third and fourth control points are associated with different reference pictures, scaling a given one of the two control points based on a motion vector of the given one control point to point to a reference picture of another control point of the two control points.
Clause 43. The method of any of clauses 39-42, wherein the first, second, third and fourth control points are determined by using a temporal candidate determination used in a regular merge mode.
Clause 44. The method of any of clauses 30-43, wherein a first length of the bottom-right row is based on a width of the current video block.
Clause 45. The method of clause 44, wherein the first length is determined based on the width and a first factor.
Clause 46. The method of clause 45, wherein the first factor is ½.
Clause 47. The method of any of clauses 30-46, wherein a second length of the bottom-right column is based on a height of the current video block.
Clause 48. The method of clause 47, wherein the second length is determined based on the height and a second factor.
Clause 49. The method of clause 48, wherein the second factor is ½.
Clause 50. The method of any of clauses 1-15, wherein the at least one subblock comprises a non-adjacent subblock of the temporal block, and wherein the non-adjacent subblock is determined based on a plurality of non-adjacent temporal neighboring blocks.
Clause 51. The method of any of clauses 1-15, wherein the at least one subblock comprises a collocated subblock of the temporal block, and wherein the motion information of the collocated subblock is determined by using a temporal candidate determination used in a regular merge mode.
Clause 52. The method of clause 51, wherein a reference picture index of the motion information of the collocated subblock comprises a predefined value.
Clause 53. The method of clause 51 or clauses 52, wherein determining the motion information of the collocated subblock comprises: determining a reference picture from a plurality of candidate reference pictures based on a plurality of scaling factors of the plurality of candidate reference pictures; and determining the motion information based on the reference picture.
Clause 54. The method of clause 54, wherein a difference between the scaling factor of the reference picture and a predefined value is the closest among a plurality of differences between scaling factors of a plurality of pictures and the predefined value.
Clause 55. The method of clause 54, wherein the predefined value comprises 1.
Clause 56. The method of any of clauses 1-55, wherein a size of the at least one subblock is predefined.
Clause 57. A method for video processing, comprising: determining, for a conversion between a current video block of a video and a bitstream of the video, motion information and location information of at least one spatial subblock of the current video block; determining an affine candidate of the current video block by applying a regression process to the current video block based on the motion information and the location information of the at least one spatial subblock; and performing the conversion based on the affine candidate.
Clause 58. The method of clause 57, wherein the at least one spatial subblock of the current video block comprises at least one of: a spatial subblock adjacent to the current video block, or a spatial subblock non-adjacent to the current video block.
Clause 59. The method of clause 57 or clause 58, wherein the at least one spatial subblock comprises at least a part of a set of spatial subblocks used to determine at least one spatial merge candidate of the current video block.
Clause 60. The method of clause 59, wherein the at least one spatial subblock further comprises a spatial subblock not in the set of spatial subblocks.
Clause 61. The method of clause 59 or clause 60, wherein the at least one spatial merge candidate comprises at least one of: a first spatial neighbor candidate left to the current video block, a second spatial neighbor candidate above the current video block, a third spatial neighbor candidate right to the second spatial neighbor candidate, a fourth spatial neighbor candidate below the first spatial neighbor candidate, or a fifth spatial neighbor candidate above and left to the current video block.
Clause 62. The method of any of clauses 59-61, wherein the set of spatial subblocks is predetermined.
Clause 63. The method of any of clauses 1-62, wherein the conversion includes encoding the current video block into the bitstream.
Clause 64. The method of any of clauses 1-62, wherein the conversion includes decoding the current video block from the bitstream.
Clause 65. An apparatus for video processing comprising a processor and a non-transitory memory with instructions thereon, wherein the instructions upon execution by the processor, cause the processor to perform a method in accordance with any of clauses 1-64.
Clause 66. A non-transitory computer-readable storage medium storing instructions that cause a processor to perform a method in accordance with any of clauses 1-64.
Clause 67. A non-transitory computer-readable recording medium storing a bitstream of a video which is generated by a method performed by an apparatus for video processing, wherein the method comprises: determining motion information and location information of at least one subblock of a temporal block in a collocated frame of a current video block of the video; determining an affine candidate of the current video block by applying a regression process to the current video block based on the motion information and the location information of the at least one subblock; and generating the bitstream based on the affine candidate.
Clause 68. A method for storing a bitstream of a video, comprising: determining motion information and location information of at least one subblock of a temporal block in a collocated frame of a current video block of the video; determining an affine candidate of the current video block by applying a regression process to the current video block based on the motion information and the location information of the at least one subblock; generating the bitstream based on the affine candidate; and storing the bitstream in a non-transitory computer-readable recording medium.
Clause 69. A non-transitory computer-readable recording medium storing a bitstream of a video which is generated by a method performed by an apparatus for video processing, wherein the method comprises: determining motion information and location information of at least one spatial subblock of a current video block of the video; determining an affine candidate of the current video block by applying a regression process to the current video block based on the motion information and the location information of the at least one spatial subblock; and generating the bitstream based on the affine candidate.
Clause 70. A method for storing a bitstream of a video, comprising: determining motion information and location information of at least one spatial subblock of a current video block of the video; determining an affine candidate of the current video block by applying a regression process to the current video block based on the motion information and the location information of the at least one spatial subblock; generating the bitstream based on the affine candidate; and storing the bitstream in a non-transitory computer-readable recording medium.

### Example Device

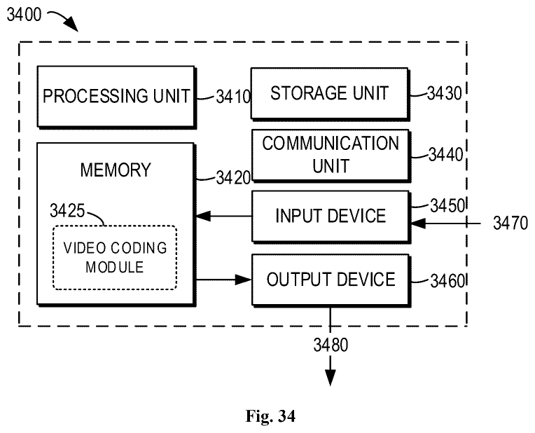

FIG. 34 illustrates a block diagram of a computing device 3400 in which various embodiments of the present disclosure can be implemented. The computing device 3400 may be implemented as or included in the source device 110 (or the video encoder 114 or 200) or the destination device 120 (or the video decoder 124 or 300).

It would be appreciated that the computing device 3400 shown in FIG. 34 is merely for purpose of illustration, without suggesting any limitation to the functions and scopes of the embodiments of the present disclosure in any manner.

As shown in FIG. 34, the computing device 3400 includes a general-purpose computing device 3400. The computing device 3400 may at least comprise one or more processors or processing units 3410, a memory 3420, a storage unit 3430, one or more communication units 3440, one or more input devices 3450, and one or more output devices 3460.

In some embodiments, the computing device 3400 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 3400 can support any type of interface to a user (such as “wearable” circuitry and the like).

The processing unit 3410 may be a physical or virtual processor and can implement various processes based on programs stored in the memory 3420. In a multi-processor system, multiple processing units execute computer executable instructions in parallel so as to improve the parallel processing capability of the computing device 3400. The processing unit 3410 may also be referred to as a central processing unit (CPU), a microprocessor, a controller or a microcontroller.

The computing device 3400 typically includes various computer storage medium. Such medium can be any medium accessible by the computing device 3400, including, but not limited to, volatile and non-volatile medium, or detachable and non-detachable medium. The memory 3420 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 3430 may be any detachable or non-detachable medium and may include a machine-readable medium such as a memory, flash memory drive, magnetic disk or another other media, which can be used for storing information and/or data and can be accessed in the computing device 3400.

The computing device 3400 may further include additional detachable/non-detachable, volatile/non-volatile memory medium. Although not shown in FIG. 34, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 3440 communicates with a further computing device via the communication medium. In addition, the functions of the components in the computing device 3400 can be implemented by a single computing cluster or multiple computing machines that can communicate via communication connections. Therefore, the computing device 3400 can operate in a networked environment using a logical connection with one or more other servers, networked personal computers (PCs) or further general network nodes.

The input device 3450 may be one or more of a variety of input devices, such as a mouse, keyboard, tracking ball, voice-input device, and the like. The output device 3460 may be one or more of a variety of output devices, such as a display, loudspeaker, printer, and the like. By means of the communication unit 3440, the computing device 3400 can further communicate with one or more external devices (not shown) such as the storage devices and display device, with one or more devices enabling the user to interact with the computing device 3400, or any devices (such as a network card, a modem and the like) enabling the computing device 3400 to communicate with one or more other computing devices, if required. Such communication can be performed via input/output (I/O) interfaces (not shown).

In some embodiments, instead of being integrated in a single device, some or all components of the computing device 3400 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 3400 may be used to implement video encoding/decoding in embodiments of the present disclosure. The memory 3420 may include one or more video coding modules 3425 having one or more program instructions. These modules are accessible and executable by the processing unit 3410 to perform the functionalities of the various embodiments described herein.

In the example embodiments of performing video encoding, the input device 3450 may receive video data as an input 3470 to be encoded. The video data may be processed, for example, by the video coding module 3425, to generate an encoded bitstream. The encoded bitstream may be provided via the output device 3460 as an output 3480.

In the example embodiments of performing video decoding, the input device 3450 may receive an encoded bitstream as the input 3470. The encoded bitstream may be processed, for example, by the video coding module 3425, to generate decoded video data. The decoded video data may be provided via the output device 3460 as the output 3480.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current video block of a video and a bitstream of the video, motion information and location information of at least one subblock of a temporal block in a collocated frame of the current video block;
determining an affine candidate of the current video block by applying a regression process to the current video block based on the motion information and the location information of the at least one subblock; and
performing the conversion based on the affine candidate.

2. The method of claim 1, wherein the at least one subblock of the temporal block comprises at least one of: a subblock adjacent to the temporal block, a subblock non-adjacent to the temporal block, or a collocated subblock in the temporal block, and/or
wherein a first size of the temporal block is a same size with a second size of the current video block, and/or
wherein a first position of the temporal block in the collocated frame is a same position as a second position of the current video block in a current frame including the current video block.

3. The method of claim 1, wherein a motion shift is between a first position of the temporal block in the collocated frame and a second position of the current video block in a current frame including the current video block,
wherein the method further comprises:
determining whether a motion vector associated with at least one spatial neighbor candidate uses a collocated picture of the current video block as a reference picture;
in accordance with a determination that the motion vector uses the collocated picture as the reference picture, determining the motion shift to be the motion vector; and
in accordance with a determination that no motion vector associated with the at least one spatial neighbor candidate uses the collocated picture as the reference picture, determining the motion shift to be a predefined vector, wherein the predefined vector comprises a zero vector,
wherein the at least one spatial neighbor candidate comprises at least one of: a first spatial neighbor candidate left to the current video block, a second spatial neighbor candidate above the current video block, a third spatial neighbor candidate right to the second spatial neighbor candidate, a fourth spatial neighbor candidate below the first spatial neighbor candidate, or a fifth spatial neighbor candidate above and left to the current video block, and/or
wherein the motion vector is determined for the at least one spatial neighbor candidate based on an order of the first spatial neighbor candidate, the second spatial neighbor candidate, the third spatial neighbor candidate, the fourth spatial neighbor candidate, or the fifth spatial neighbor candidate.

4. The method of claim 1, wherein a motion shift is between a first position of the temporal block in the collocated frame and a second position of the current video block in a current frame including the current video block,
wherein the method further comprises: determining the motion shift to be a predefined vector, wherein the predefined vector comprises a zero vector, or
wherein the method further comprises: determining at least one relative location from the at least one subblock to the current video block; and determining the location information of the at least one subblock by subtracting the motion shift from the relative location,
wherein determining the location information of the at least one subblock comprises:
determining whether the motion shift is a zero vector;
in accordance with a determination that the motion shift is the zero vector, determining the location information of the at least one subblock to be the relative location; and
in accordance with a determination that the motion shift is not the zero vector, determining the location information of the at least one subblock by subtracting the motion shift from the relative location.

5. The method of claim 1, wherein the current video block comprises a set of collocated frames, a number of collocated frames in the set of collocated frames is fixed or adaptive,
wherein the set of collocated frames comprises a candidate collocated frame associated with a temporal candidate determination process, information of the candidate collocated frame being included in a slice header in the bitstream, and/or
wherein the method further comprises: selecting the set of collocated frames from a plurality of reference frames based on at least one of:
a sorting of picture order count distances of the plurality of reference frames relative to a current frame comprising the current video block,
a sorting of quantization parameters of the plurality of reference frames, or
a sorting of temporal layers associated with the plurality of reference frames.

6. The method of claim 1, wherein the at least one subblock comprises an adjacent subblock of the temporal block, and
wherein the motion information of the adjacent subblock is determined based on at least one of:
a right column adjacent to the temporal block,
a bottom row adjacent to the temporal block, or
a bottom-right corner adjacent to the right column and the bottom row.

7. The method of claim 6, wherein the motion information of the adjacent subblock is determined by using a temporal candidate determination used in a regular merge mode, and/or
wherein a reference picture index associated with the motion information comprises a predefined value, and/or
wherein determining the motion information comprises:
determining a reference picture from a plurality of candidate reference pictures based on a plurality of scaling factors of the plurality of candidate reference pictures; and
determining the motion information based on the reference picture,
wherein a difference between the scaling factor of the reference picture and a predefined value is a closest among a plurality of differences between scaling factors of a plurality of pictures and the predefined value, wherein the predefined value comprises 1.

8. The method of claim 6, further comprising:
determining the motion information of the adjacent subblock by applying a linear interpolation to at least one of:
first motion information of a top-right corner above the right column and second motion information of the bottom-right corner, or
third motion information of a bottom-left corner left to the bottom row and the second motion information of the bottom-right corner,
wherein the first motion information of the top-right corner comprises at least one of: spatial motion information of the top-right corner or temporal motion information of the top-right corner,
wherein the third motion information of the bottom-left corner comprises at least one of: spatial motion information of the bottom-left corner or temporal motion information of the bottom-left corner,
wherein the second motion information of the bottom-right corner comprises temporal motion information of the bottom-right corner, and/or
wherein the top-right corner, the bottom-left corner and the bottom-right corner are associated with a same reference picture.

9. The method of claim 1, further comprising:
in accordance with a determination that two control points of a top-right corner, a bottom-left corner and a bottom-right corner are associated with different reference pictures, ceasing applying a linear interpolation, and/or
in accordance with a determination that two control points of the top-right corner, the bottom-left corner and the bottom-right corner have different reference pictures, scaling a first control point of the two control points based on a motion vector of the first control point to point to the reference picture of a second control point of the two control points.

10. The method of claim 1, wherein the at least one subblock comprises an adjacent subblock of the temporal block, and
wherein the motion information of the adjacent subblock is determined based on at least one of:
a first temporal neighboring block at a center position of a co-located block of the current video block, or
a second temporal neighboring block at a position right to and below a co-located block of the current video block.

11. The method of claim 1, wherein the at least one subblock comprises a non-adjacent subblock of the temporal block, and
wherein the motion information of the non-adjacent subblock is determined based on at least one of: a bottom-right column below and right to the temporal block, or a bottom-right row below and right to the temporal block.

12. The method of claim 11, wherein the motion information of the non-adjacent subblock is determined by using a temporal candidate determination used in a regular merge mode, and/or
wherein a reference picture index associated with the motion information comprises a predefined value, and/or
wherein determining the motion information comprises:
determining a reference picture from a plurality of candidate reference pictures based on a plurality of scaling factors of the plurality of candidate reference pictures; and
determining the motion information based on the reference picture,
wherein a difference between the scaling factor of the reference picture and a predefined value is a closest among a plurality of differences between scaling factors of a plurality of pictures and the predefined value, wherein the predefined value comprises 1.

13. The method of claim 11, further comprising:
determining the motion information of the non-adjacent subblock by applying a linear interpolation to at least one of: fourth and fifth motion information associated with the bottom-right column, or sixth and seventh motion information associated with the bottom-right row,
wherein at least one of the fourth motion information or the fifth motion information or the sixth motion information or the seventh motion information comprises temporal motion information, and/or
wherein determining the motion information of the non-adjacent subblock by applying a linear interpolation comprises: determining a first control point and a second control point in the bottom-right column; and determining the motion information of the non-adjacent subblock by applying the linear interpolation in a vertical direction to the fourth and fifth motion information of the first and second control points, or
wherein determining the motion information of the non-adjacent subblock by applying a linear interpolation comprises: determining a third control point and a fourth control point in the bottom-right row; and determining the motion information of the non-adjacent subblock by applying the linear interpolation in a horizontal direction to the sixth and seventh motion information of the third and fourth control points, and/or
wherein the first, second, third and fourth control points are associated with a same reference picture.

14. The method of claim 13, further comprising:
in accordance with a determination that two of the first, second, third and fourth control points are associated with different reference pictures, ceasing applying the linear interpolation, and/or
in accordance with a determination that two of the first, second, third and fourth control points are associated with the different reference pictures, scaling a given one of the two control points based on a motion vector of the given one control point to point to a reference picture of another control point of the two control points,
wherein the first, second, third and fourth control points are determined by using a temporal candidate determination used in a regular merge mode,
wherein a first length of the bottom-right row is based on a width of the current video block, wherein the first length is determined based on the width and a first factor, and/or
wherein a second length of the bottom-right column is based on a height of the current video block, wherein the second length is determined based on the height and a second factor.

15. The method of claim 1, wherein the at least one subblock comprises a non-adjacent subblock of the temporal block, and
wherein the non-adjacent subblock is determined based on a plurality of non-adjacent temporal neighboring blocks.

16. The method of claim 1, wherein the at least one subblock comprises a collocated subblock of the temporal block, and
wherein the motion information of the collocated subblock is determined by using a temporal candidate determination used in a regular merge mode,
wherein a reference picture index of the motion information of the collocated subblock comprises a predefined value, and/or
wherein determining the motion information of the collocated subblock comprises:
determining a reference picture from a plurality of candidate reference pictures based on a plurality of scaling factors of the plurality of candidate reference pictures; and
determining the motion information based on the reference picture,
wherein a difference between the scaling factor of the reference picture and a predefined value is a closest among a plurality of differences between scaling factors of a plurality of pictures and the predefined value.

17. The method of claim 1, wherein the conversion includes encoding the current video block into the bitstream, and/or
wherein the conversion includes decoding the current video block from the bitstream.

18. An apparatus for video processing comprising a processor and a non-transitory memory with instructions thereon, wherein the instructions upon execution by the processor, cause the processor to:
determine, for a conversion between a current video block of a video and a bitstream of the video, motion information and location information of at least one subblock of a temporal block in a collocated frame of the current video block;
determine an affine candidate of the current video block by applying a regression process to the current video block based on the motion information and the location information of the at least one subblock; and
perform the conversion based on the affine candidate.

19. A non-transitory computer-readable storage medium storing instructions that cause a processor to perform a method comprising:
determining, for a conversion between a current video block of a video and a bitstream of the video, motion information and location information of at least one subblock of a temporal block in a collocated frame of the current video block;
determining an affine candidate of the current video block by applying a regression process to the current video block based on the motion information and the location information of the at least one subblock; and
performing the conversion based on the affine candidate.

20. A non-transitory computer-readable recording medium storing a bitstream of a video which is generated by a method performed by an apparatus for video processing, wherein the method comprises:
determining motion information and location information of at least one subblock of a temporal block in a collocated frame of a current video block of the video;
determining an affine candidate of the current video block by applying a regression process to the current video block based on the motion information and the location information of the at least one subblock; and
generating the bitstream based on the affine candidate.
